(19) United States
(12) Patent Application Publication
(10) Pub. No.: US 2024/0291536 A1
(43) Pub. Date: Aug. 29, 2024

(54) CONFIGURING MULTI-STA SENSING-SPECIFIC FEEDBACK USING NDPA AND TRIGGER FRAMES

(71) Applicant: INTERDIGITAL PATENT HOLDINGS, INC., Wilmington, DE (US)

(72) Inventors: Satyanarayana Katla, London (GB); Onur Sahin, London (GB); Mahmoud Saad, Montreal (CA); Rui Yang, Greenlawn, NY (US); Zinan Lin, Basking Ridge, NJ (US)

(73) Assignee: INTERDIGITAL PATENT HOLDINGS, INC., Wilmington, DE (US)

(21) Appl. No.: 18/569,028

(22) PCT Filed: Jun. 10, 2022
(86) PCT No.: PCT/US2022/032964

§ 371 Date: Dec. 11, 2023

Related U.S. Application Data
(60) Provisional application No. 63/209,727, filed on Jun. 11, 2021.
(60) Provisional application No. 63/233,532, filed on Aug. 16, 2021.
(60) Provisional application No. 63/254,415, filed on Oct. 11, 2021.
(60) Provisional application No. 63/305,971, filed on Feb. 2, 2022.
(60) Provisional application No. 63/309,179, filed on Feb. 11, 2022.

(51) Int. Cl. H04B 7/06; H04W 8/22; H04W 24/10

(52) U.S. Cl. CPC H04B 7/0626; H04W 8/22; H04W 24/10

(57) ABSTRACT

Methods and apparatuses are described herein for configuring multiple station (multi-STA) sensing-specific feedback. For example, a sensing initiator station (STA) may transmit, to first and second sensing responder STAs, a null data packet (NDP) announcement (NDPA) frame indicating one or more sensing feedback types that the first and second sensing responder STAs are to respond. The sensing initiator STA may transmit, to the first and second sensing responder STAs, an NDP frame. The sensing initiator STA may transmit, to the first and second sensing responder STAs, a trigger frame indicating one or more resources allocated for sensing measurement reports from the first and second sensing responder STAs. The sensing initiator STA may receive, from the first and second sensing responder STAs, using the one or more resources, the sensing measurement reports determined based on the one or more sensing feedback types.

### CROSS REFERENCE TO RELATED APPLICATIONS

This application claims the benefit of U.S. Provisional Application No. 63/209,727, filed Jun. 11, 2021, U.S. Provisional Application No. 63/233,532, filed Aug. 16, 2021, U.S. Provisional Application No. 63/254,415, filed Oct. 11, 2021, U.S. Provisional Application No. 63/305,971, filed Feb. 2, 2022 and U.S. Provisional Application No. 63/309,179, filed Feb. 11, 2022, which are incorporated by reference as if fully set forth.

### BACKGROUND

Multicarrier joint radar and wireless communication systems may use an underlying wireless system, for example, Wireless Local Area Network (WLAN), where the wireless system is facilitated with sensing abilities such as detecting the presence of people, monitoring the well-being of a person, localization of a person/device, measuring the velocity of a moving object, detecting the obstacles. The key metrics used in state-of-the-art for quantifying the sensing performance include received signal strength indicator (RSSI), channel state information (CSI), angular resolution, range resolution, time-of-flight (ToF). The existing mechanism mainly focuses on the CSI metric since CSI provides finer granularity, while other metrics (e.g. RSS, ToF) provide a coarse measure of detection. For example, in the current IEEE 802.11 standards, there are two types of channel sounding: trigger based NDP (TB-NDP) and non-trigger based NDP (non-TB NDP). However, the current channel sounding techniques do not allow sensing measurements specific feedback, which is critical for improving sensing with high fidelity. Thus, methods and apparatuses that enables the sensing measurements specific feedback are needed.

### SUMMARY

Methods and apparatuses are described herein for configuring multiple station (multi-STA) sensing-specific feedback using Null Data Packet (NDP) Announcement (NADPA) and trigger frames. For example, a sensing initiator station (STA) may transmit, to a first sensing responder STA and a second sensing responder STA, a null data packet (NDP) announcement (NDPA) frame indicating one or more sensing feedback types that the first sensing responder STA and the second sensing responder STA are to respond. The sensing initiator STA may transmit, to the first sensing responder STA and the second sensing responder STA, an NDP frame. The sensing initiator STA may transmit, to the first sensing responder STA and the second sensing responder STA, a trigger frame indicating one or more resources allocated for sensing measurement reports from the first sensing responder STA and the second sensing responder STA. The sensing initiator STA may receive, from the first sensing responder STA and the second sensing responder STA, using the one or more resources, the sensing measurement reports determined based on the one or more sensing feedback types.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a diagram illustrating an example non-trigger based channel sounding;

FIG. 2B is a diagram illustrating an example trigger based channel sounding;

FIG. 3 is a flow chart illustrating an example procedure for configuring sensing-specific feedback based on null data packet (NDP) announcement (NDPA) and trigger frame transmission.

FIG. 4A is a diagram illustrating an example capabilities element format;

FIG. 4B is a diagram illustrating an example format for the Medium Access Control (MAC) capability information field illustrated in FIG. 4A;

FIG. 4C is a diagram illustrating an example format for the Physical layer (PHY) capability element information field illustrated in FIG. 4A;

FIG. 5 is a message sequence chart which illustrates example signaling for multi-STA assisted sensing of probe frames when one of sensing responders is a sensing transmitter while a sensing initiator is both receiver and processor;

FIG. 6A is a diagram illustrating an example NDPA frame;

FIG. 6B is a diagram illustrating an example STA info field of the NDPA frame illustrated in FIG. 6A;

FIG. 7A is a diagram illustrating an example trigger frame;

FIG. 7B is a diagram illustrating an example format for the Common Info field illustrated in FIG. 7A;

FIG. 7C is a diagram illustrating an example format for the User Info field illustrated in FIG. 7A;

FIG. 8 is a system diagram 800 illustrating an example scenario where a sensing responder 810 is both a sensing receiver and a sensing processor;

FIG. 9 is a signaling diagram 900 which further illustrates the messaging shown and described with respect to FIG. 8;

FIG. 10 is a message sequence chart 1000 which illustrates the messaging shown and described with respect to FIGS. 8 and 9;

FIG. 11 is a system diagram 1100 illustrating an example scenario where a sensing initiator is both a sensing transmitter and a sensing processor;

FIG. 12 is a signaling diagram 1200 which further illustrates the messaging shown and described with respect to FIG. 11;

FIG. 13 is a message sequence chart 1300 which illustrates the messaging shown and described with respect to FIGS. 11 and 12;

FIG. 14 is a system diagram 1400 illustrating an example scenario where a sensing initiator is both a sensing receiver and a sensing processor;

FIG. 15 is a signaling diagram 1500 which further illustrates the messaging shown and described with respect to FIG. 14;

FIG. 16 is a message sequence chart 1600 which illustrates the messaging shown and described with respect to FIGS. 14 and 15;

FIG. 17 is a system diagram 1700 illustrating an example scenario where a sensing responder 1710 is both a sensing transmitter and a sensing processor;

FIG. 18 is a signaling diagram 1800 which further illustrates the messaging shown and described with respect to FIG. 17;

FIG. 19 is a message sequence chart 1900 which illustrates the messaging shown and described with respect to FIGS. 17 and 18;

FIG. 20 is a signaling chart which illustrates an example sensing procedure 2000 based on UL channel information with multiple APs;

FIG. 21 illustrates example STA info fields;

FIG. 22 is a signaling diagram which illustrates an example threshold-based non-TB sounding sequence; and

FIG. 23 is a signaling diagram which illustrates an example threshold-based TB sounding sequence.

### DETAILED DESCRIPTION

Some implementations provide a method performed by a first station (STA). A request is transmitted, to a second STA, for an indication of a sensing capability of the second STA. The indication of the sensing capability is received from the second STA, responsive to the request. An indication of a feedback type and an indication of a feedback parameter are transmitted to the second STA, responsive to the indication of the sensing capability.

In some implementations, the request includes a probe request. In some implementations, indication of the sensing capability includes an indication of a physical layer (PHY) capability. In some implementations, the indication of the sensing capability includes an indication of a sensing bandwidth, an indication of a sensing resolution, an indication of an angle of arrival resolution, an indication of a sensing signal to noise ratio (SNR), and/or an indication of a field-of-view. In some implementations, the indication of the feedback type is transmitted in a null data packet announcement (NDPA) frame. In some implementations, the indication of the feedback type includes an indication of a type of sensing feedback corresponding to the sensing capability. In some implementations, the indication of the feedback type includes an indication of a measurement metric. In some implementations, the indication of the feedback type includes an indication that feedback will indicate a time of flight (ToF), an indication that feedback will indicate a time difference of arrival (TDOA), an indication that feedback will indicate an angle of arrival (AoA), an indication that feedback will indicate a channel state information (CSI), an indication that feedback will indicate a full CSI, an indication that feedback will indicate a compressed CSI, an indication that feedback will indicate a received signal strength (RSS), an indication that feedback will indicate a location, and/or an indication that feedback will indicate a mobility. In some implementations, the indication of the feedback parameter includes an indication of a parameter for sensing feedback corresponding to the sensing capability. In some implementations, the indication of the feedback parameter includes an indication of a feedback resolution and/or an indication of a feedback accuracy.

Some implementations provide a station (STA) configured for sensing by proxy. The STA includes transmitter circuitry configured to transmit, to a second STA, a request for an indication of a sensing capability of the second STA. The STA also includes receiver circuitry configured to receive, from the second STA, responsive to the request, the indication of the sensing capability. The transmitter circuitry is also configured to transmit, to the second STA, responsive to the indication of the sensing capability, an indication of a feedback type and an indication of a feedback parameter.

In some implementations, the request includes a probe request. In some implementations, the indication of the sensing capability includes an indication of a physical layer (PHY) capability. In some implementations, the indication of the sensing capability includes an indication of a sensing bandwidth, an indication of a sensing resolution, an indication of an angle of arrival resolution, an indication of a sensing signal to noise (SNR), and/or an indication of a field-of-view. In some implementations, the transmitter circuitry is configured to transmit the indication of the feedback type in a null data packet announcement (NDPA) frame. In some implementations, the indication of the feedback type includes an indication of a type of sensing feedback corresponding to the sensing capability. In some implementations, the indication of the feedback type includes an indication of a measurement metric. In some implementations, the indication of the feedback type includes an indication that feedback will indicate a time of flight (ToF), an indication that feedback will indicate a time difference of arrival (TDOA), an indication that feedback will indicate an angle of arrival (AoA), an indication that feedback will indicate a channel state information (CSI), an indication that feedback will indicate a full CSI, an indication that feedback will indicate a compressed CSI, an indication that feedback will indicate a received signal strength (RSS), an indication that feedback will indicate a location, and/or an indication that feedback will indicate a mobility. In some implementations, the indication of the feedback parameter includes an indication of a parameter for sensing feedback corresponding to the sensing capability. In some implementations, the feedback parameter includes an indication of a feedback resolution and/or an indication of a feedback accuracy.

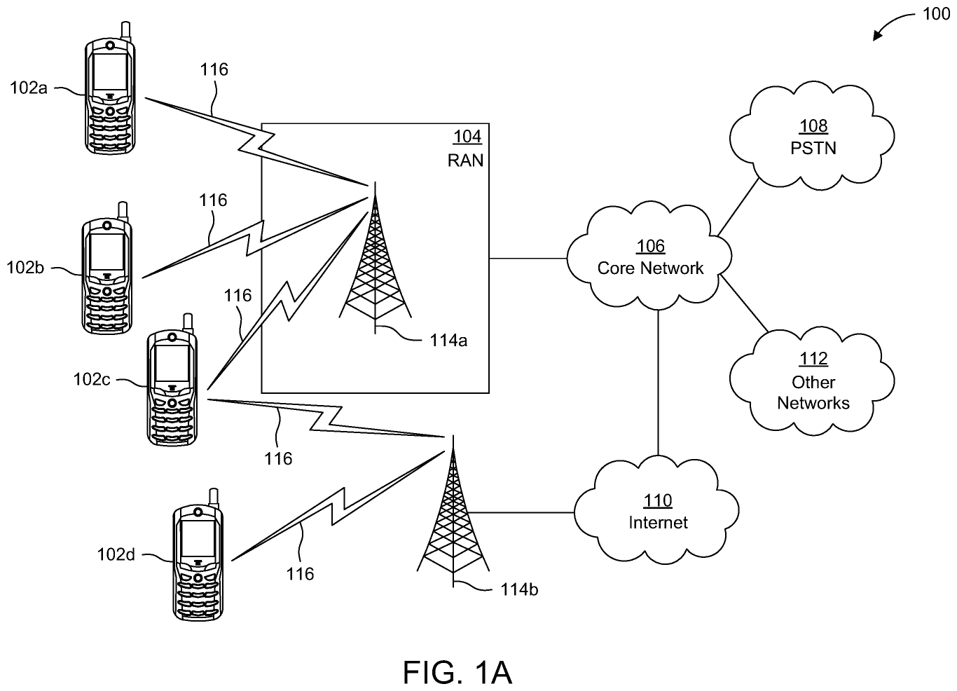

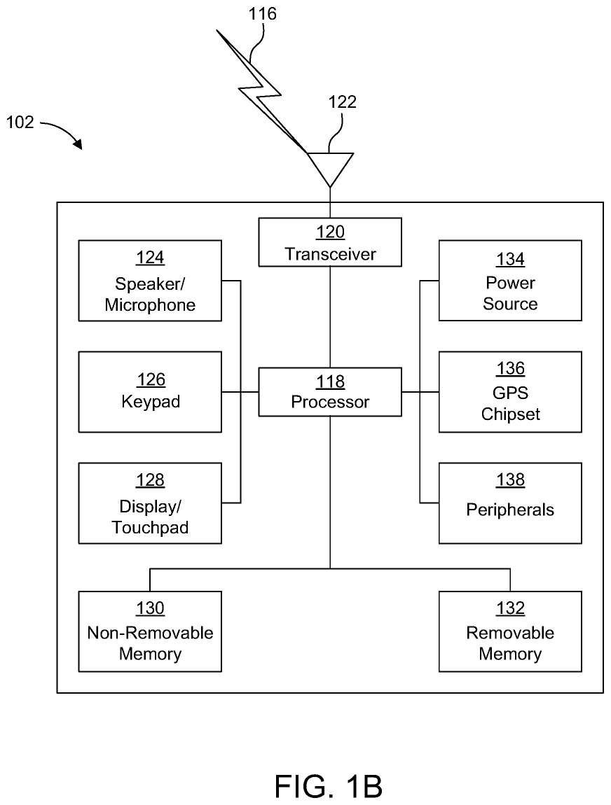

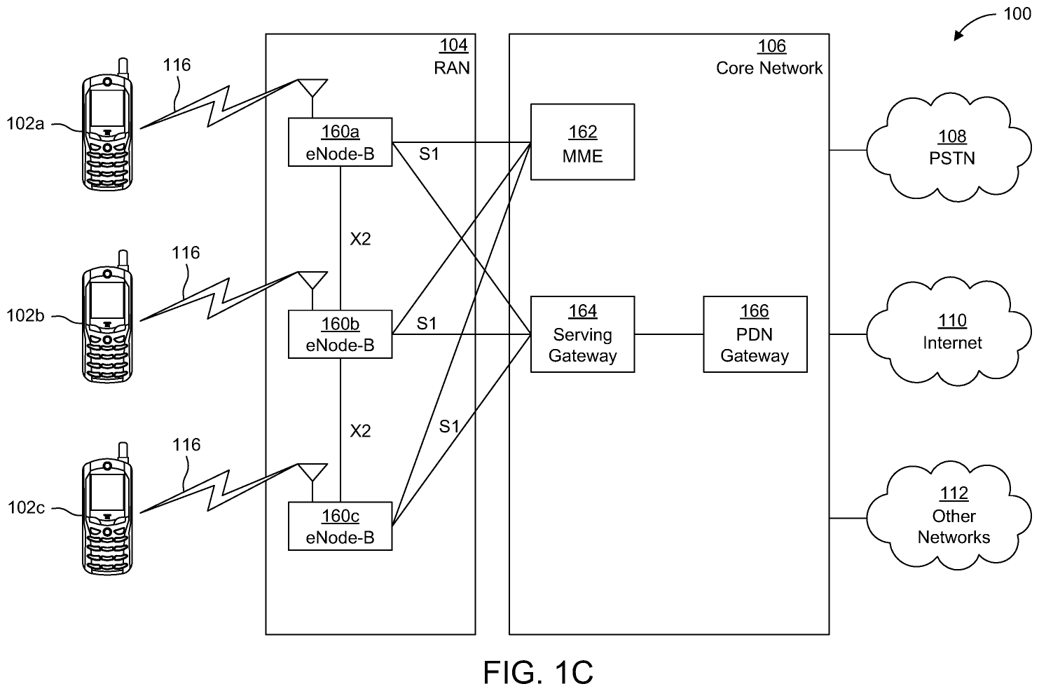

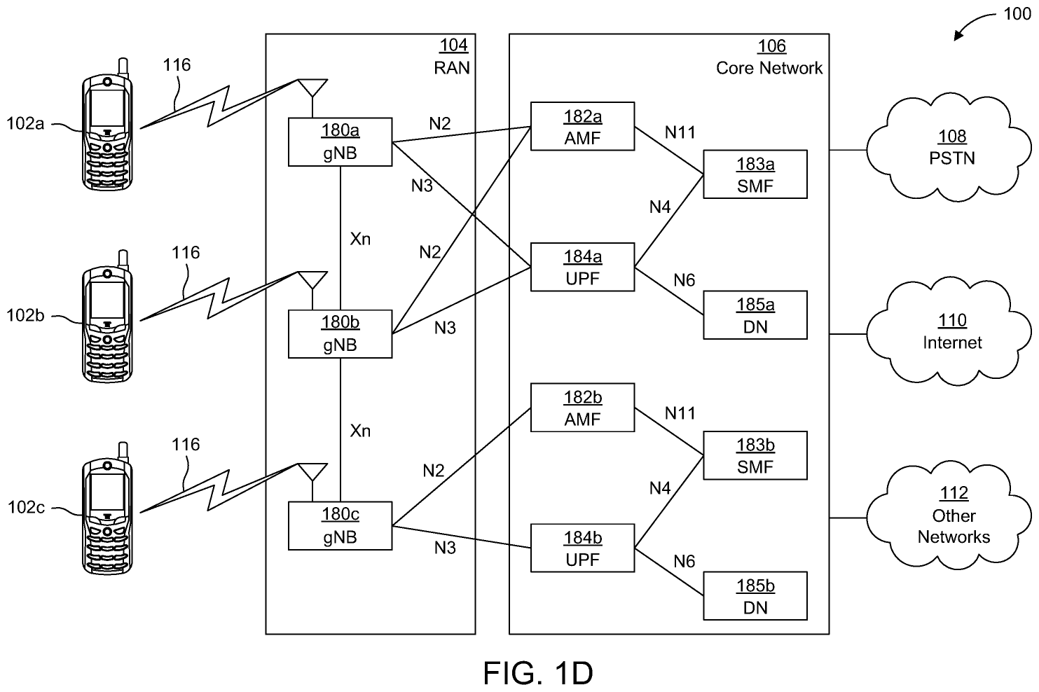

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Joint radar and communication systems are considered as a coexistence mechanism to the ever-increasing demand for spectrum, due to services with high bandwidth requirements and the exponential increase in the number of connected devices. Such joint system allows the communication radar and the communication systems to operate in the same bandwidth, without causing too much interference to each other.

The multicarrier joint radar and communication mechanisms may use an underlying wireless system (i.e. WLAN) where the wireless system is facilitated with sensing abilities, such as detecting the presence of people, monitoring the well-being of a person, localization of a person/device (coarse/fine), measuring the velocity of a moving object, and/or detecting the obstacles.

The key metrics used in state-of-the-art for quantifying the sensing performance may include received signal strength indicator (RSSI), channel state information (CSI), angular resolution, range resolution, time-of-flight (ToF), etc. IEEE 802.11 WLAN Sensing (SENS) mainly focuses on the channel state information (CSI) metric since CSI provides finer granularity while other metrics (e.g., RSS, ToF) provide a coarse measure of detection.

The long-training field (LTF) sequence, for example, of the IEEE 802.11 n/ac/ax, may be used for sensing as well. The LTFs may be necessary for demodulation of the data portion of the PPDU and/or for channel estimation during a null data packet (NDP), which is referred to as channel sounding. The channel sounding may include three (or four for MU MIMO) steps: (1) Transmission of NDP announcement (NDPA) frame, specifying the feedback type; (2) Transmission of NDP sequence; (3) Transmission of trigger frame, specifying the resources for UL transmission of the feedback (This is mainly for MU MIMO); and/or (4) Reception of the feedback (Typically, this is either CSI or beamforming matrix (compressed CSI)).

In some implementations, there may be different types of channel sounding. Two example types of channel sounding are trigger based NDP (TB-NDP) and non-trigger based NDP (non-TB NDP).

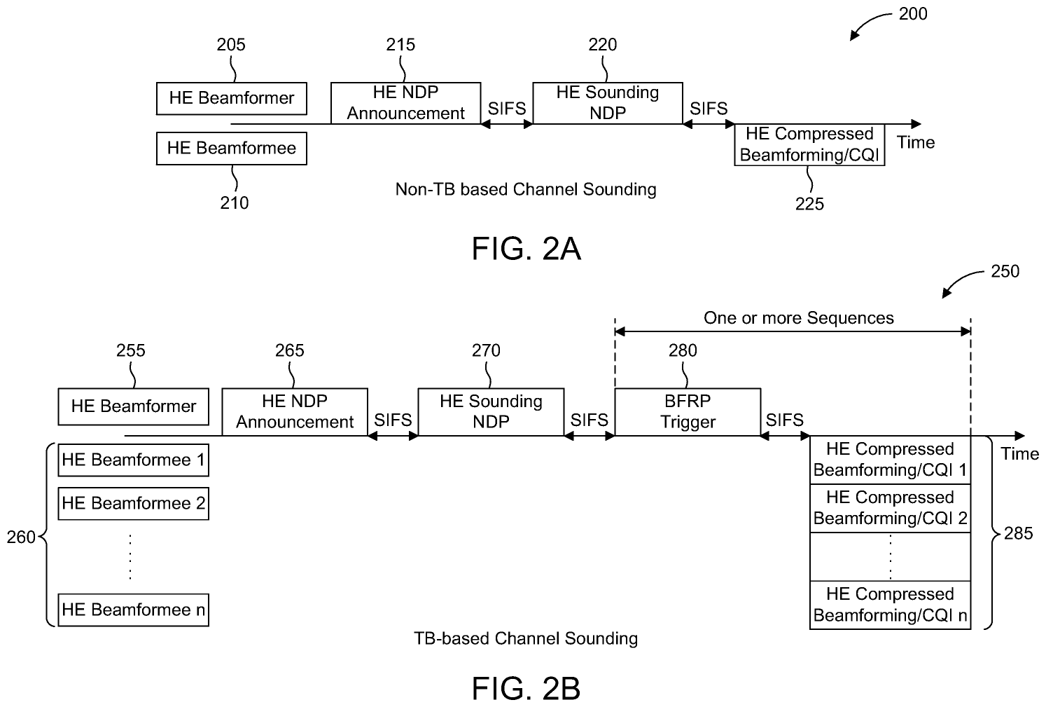

FIG. 2A is a diagram illustrating example non-trigger (non-TB) based channel sounding 200 between an HE beamformer 205 and an HE beamformer 210. In this context, a beamformer transmits information using a precoder (e.g., directionally), and the beamformee receives the signal transmitted by the beamformer. HE beamformer 205 transmits an HE NDP announcement (NDPA) 215 to HE beamformee 210, and after an SIFS, transmits an HE sounding NDP 220 to HE beamformee 210. After transmitting HE sounding NDP 220, HE beamformer 200 listens for and receives an HE compressed beamforming/CQI frame 250 from HE beamformee 210 (e.g., an SIFS after transmitting the HE sounding NDP 220).

FIG. 2B is a diagram illustrating example trigger (TB) based channel sounding, for example, using IEEE 802.11ax. HE beamformer 255 transmits an HE NDP announcement (NDPA) 265 to HE beamformees 1-n 260. After transmitting the HE NDPA 265 (e.g., after an SIFS), HE beamformer 255 transmits an HE sounding NDP 270 to HE beamformees 1-n 260. After transmitting the HE sounding NDP 270 (e.g., after an SIFS), HE beamformer 255 transmits a Beam Forming Report Poll (BFRP) Trigger frame 280 to HE beamformees 1-n 260 (e.g., an SIFS after transmitting the HE sounding NDP 270). After BFRP Trigger frame 280, HE beamformer 200 listens for and receives an HE compressed beamforming/CQI 285 from each of HE beamformees 1-n 260 (e.g., an SIFS after transmitting BFRP Trigger frame 280).

As illustrated in FIGS. 2A and 2B, a high efficiency (HE) beamformer may act as an NDPA transmitter, and an HE beamformee act as an NDPA receiver. For SU MIMO, non-TB based channel sounding may be preferred as shown in FIG. 2A, while for MU MIMO, TB-based channel sounding may be employed as shown in FIG. 2B. In some implementations, a difference between the two channel sounding procedures may lie in the trigger frame. For example, in the MU MIMO case, the trigger frame indicates the resource unit allocations among multiple STAs for UL transmission. In other words, the feedback may be transmitted using the UL resources allocated for each specific STA.

In some implementations, the channel sounding described is pertinent only to data communication, e.g., where the feedback requested is either a compressed beamforming matrix (compressed CSI matrix) or channel quality indicator (CQI). Accordingly, in order to enable the sensing using the channel sounding described above, in some implementations, sensing feedback types are configured; e.g., where the beamformee, based on receiving the NDP, performs sensing based measurements based on a configuration provided in the NDPA frame. For example, in some implementations, the NDPA frame indicates a configuration type and/or a configuration parameter for the sensing based measurements.

In the various examples described herein, a sensing initiator is a STA that initiates a WLAN sensing session, and a sensing responder is a STA that participates in a WLAN sensing session initiated by the sensing initiator. In the IEEE 802.11bf, a sensing session corresponds to an instance of a sensing procedure with the associated scheduling if applicable, and operational parameters of that instance. During the sensing session, a sensing responder can be either a sensing transmitter or a sensing receiver.

In the various examples described herein, a sensing transmitter is a STA that transmits PPDUs used for sensing measurements in a sensing session, and a sensing receiver is a STA that receives PPDUs sent by a sensing transmitter and performs sensing measurements on the received PPDUs.

The initiator and responder roles may be distinct from the transmitter and receiver roles. For example, in some implementations, a STA may serve as both a sensing initiator and a sensing transmitter. Such a sensing initiator-transmitter may both initiate the sensing session, and transmit PPDUs used for sensing measurements in the sensing session. A further role is that of sensing processor, which may be distinct from the transmitter, receiver, initiator, and responder roles. Such a sensing processor may process measurements (e.g., raw CSI measurements) taken by the sensing receiver or receivers.

In some implementations, a STA may serve as both a sensing responder and a sensing transmitter. Such a sensing responder-transmitter may participate in a sensing session initiated by a sensing initiator, and transmit PPDUs used for sensing measurements in the sensing session.

In some implementations, a STA may serve as both a sensing initiator and a sensing receiver. Such a sensing initiator-receiver may both initiate the sensing session, receive PPDUs sent by a sensing transmitter, and perform sensing measurements on the received PPDUs.

In some implementations, a STA may serve as both a sensing responder and a sensing receiver. Such a sensing responder-receiver may participate in a sensing session initiated by a sensing initiator, receive PPDUs sent by a sensing transmitter, and perform sensing measurements on the received PPDUs.

In some implementations, a STA may serve as a sensing processor, alone or in addition to one or more other roles. For example, a STA may serve as a sensing processor alone, a sensing processor, initiator, and transmitter, a sensing processor, initiator, and receiver, a sensing processor, responder, and transmitter, or a sensing processor, responder, and receiver.

In some examples herein, STAs are assumed to be multi-static; i.e. that the STA has the choice to be acting as either a sensing transmitter or a sensing receiver. Although in this disclosure multi-static STAs are considered, the techniques, devices, methods, and procedures presented in this disclosure are applicable and/or may be extended to bistatic/multi-static STAs.

Some implementations may have the advantage of providing higher sensing resolution and/or robustness, e.g., by combining sensing measurement feedback from STAs using different configurations.

In some implementations, existing channel sounding techniques that transmit an NDP do not allow for a sensing measurement (e.g., angle of arrival, time of flight, location, full CSI, RSS)-specific feedback type in an NDPA, which in some implementations has the advantage of facilitating sensing with high fidelity.

For a sensing responder receiver to feedback the sensing measurements, resource allocation such as resource units, time as well as frame configuration using trigger frame may be needed. In some implementations, a trigger frame may specify the resources to be used for sending the sensing measurements by the sensing responder receiver to the sensing STA that is also a sensing processor. Accordingly, procedures for enabling sensing depending on configuration type may be advantageous in some implementations.

In some sensing applications, knowledge of changes in the channel between a transmitter or transmitters and a receiver or receivers may be advantageous. Channel estimation procedures in the current standard for data detection may be too tedious and inefficient for sensing purpose however. Accordingly, more efficient and simple procedures for measuring the channel variation may be advantageous in some implementations.

In some implementations, a new NDPA variant for sensing is provided, e.g., to facilitate implicit and/or explicit sensing using NDPA. This NDPA variant may facilitate more efficient sensing procedures. For example, some provide a SENS NDPA, which may include an indication for SENS NDPA variant, triggering functionality, type of sensing feedback, feedback resolution, sensing bandwidth information, support of threshold-based sensing, and MIMO set up information. In some implementations, the SENS NDPA has the advantage of facilitating more efficient sensing procedures.

Some implementations provide a threshold-based measurement and reporting procedure. For example, in some implementations, a difference between a current measured CSI and the previous measured CSI is quantified. The difference may referred to as CSI variation. In some implementations, a threshold value for CSI variation is used by the sensing receiver in the threshold-based procedure. For example, in some implementations, the a sensing receiver compares CSI variation with the threshold, and may send feedback to the sensing transmitter, e.g., in cases where the CSI variation exceeds the threshold. In some implementations, CSI variations are used to facilitate various sensing applications. Some implementations provide a threshold-based sensing protocol and the format of the threshold-based based CSI report.

Examples of multi-STA assisted sensing are described herein. In some implementations, a plurality of STAs may participate in the sensing, either sequentially or simultaneously (e.g., jointly). In some implementations, this may have the advantage of improving sensing resolution, e.g., by improving the granularity of sensing. Some implementations facilitate coarse estimation of sensing parameters by the sensing initiator, which would indicate coarse measurements (e.g., CSI, RSS, and/or ToF) to the sensing responder.

Some implementations facilitate improved sensing resolution with finer granularity, e.g., by coordination among a plurality of sensing responders. In some implementations, sensors are coordinated for trigger-based sensing and/or sensing-by-proxy applications. For example, in some implementations, coarse sensing measurements are collected in a first stage, and finer sensing results are obtained in one or more further stages. Some such implementations may include, but are not limited to: (1) signalling procedures among a coordinated set of STAs for enabling sensing measurements, where in the sensing session, the STAs transmit NDPA and trigger frames; (2) multiple different sensing feedback types for improving sensing; and (3) procedures for configuring the sensing feedback type in the NDPA frame and transmission of trigger frame for different STA configurations.

Some implementations provide multi-STA assisted sensing, e.g., for improving sensing resolution. For example, as described above, multi-STA assisted sensing may be used, e.g., where a plurality of STAs participate in sensing, either sequentially or in parallel manner with the objective of improving the sensing resolution using diversified sensing feedback types. These techniques may allow the sensing transmitter (Tx), which can be a STA initiator or a responder, to configure the sensing responder receiver (Rx) with the sensing-specific feedback.

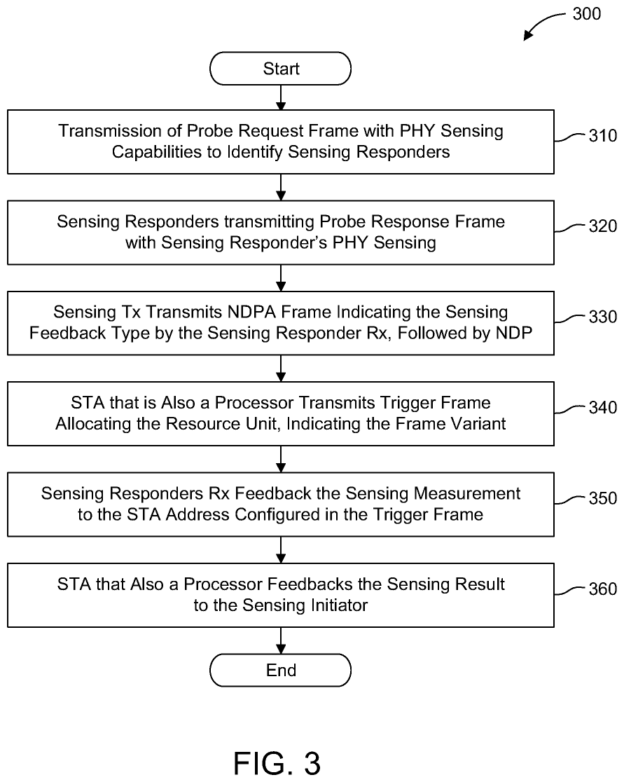

FIG. 3 is a flow chart illustrating an example procedure for configuring sensing-specific feedback based on null data packet (NDP) announcement (NDPA) and trigger frame transmission.

In step 310, a sensing initiator transmits a probe request frame to identify sensing responders and whether they are also sensing transmitters or receivers. In some implementations, the probe request frame includes an indication of sensing capabilities (e.g., PHY sensing capabilities) that the initiator desires of desired sensing responder.

In step 320, the initiator receives a probe response frame from each sensing responder. In some implementations, a probe response is only received from sensing responders that include at least one sensing capability indicated in the probe request frame. In some implementations, each probe response frame indicates the sensing capabilities (e.g., PHY sensing capabilities) of the sensing responder from which it was received.

In step 330, the sensing initiator transmits, to each sensing responder from which it received a probe response frame, an indication of a type of sensing feedback that the sensing responder should carry out for the sensing session. In some implementations, the indication of the type of sensing feedback is transmitted in an NDPA frame. In some implementations, the sensing initiator, in a sensing transmitter role, transmits an NDP after it transmits the indication of the type of sensing feedback (e.g., in an NDPA frame). In some implementations, a different STA transmits the NDP in the transmitter role.

In step 340, a STA that functions as a sensing processor transmits a trigger frame which allocates resources (e.g., one or more resource units) for the sensing receivers to feed back sensing measurements.

In step 350, the sensing responders transmit (e.g., feed back) sensing measurements to the STA that functions as a sensing processor, e.g., using the resources provided in the trigger frame and/or to a STA address configured in the trigger frame (e.g., to the STA that functions as a sensing processor).

In step 360, the STA that functions as a sensing processor transmits (e.g., feeds back) the sensing measurements and/or information based on the sensing measurements (which may be referred to as a sensing result) to the sensing initiator.

Some implementations include procedures for NDPA, NDP and trigger frame transmission under different configurations in the context of multi-STA assisted sensing (e.g., trigger-based sensing, or sensing-by-proxy) are described.

Some implementations identify a sensing responder STA using a probe request frame and a probe response frame are described herein.

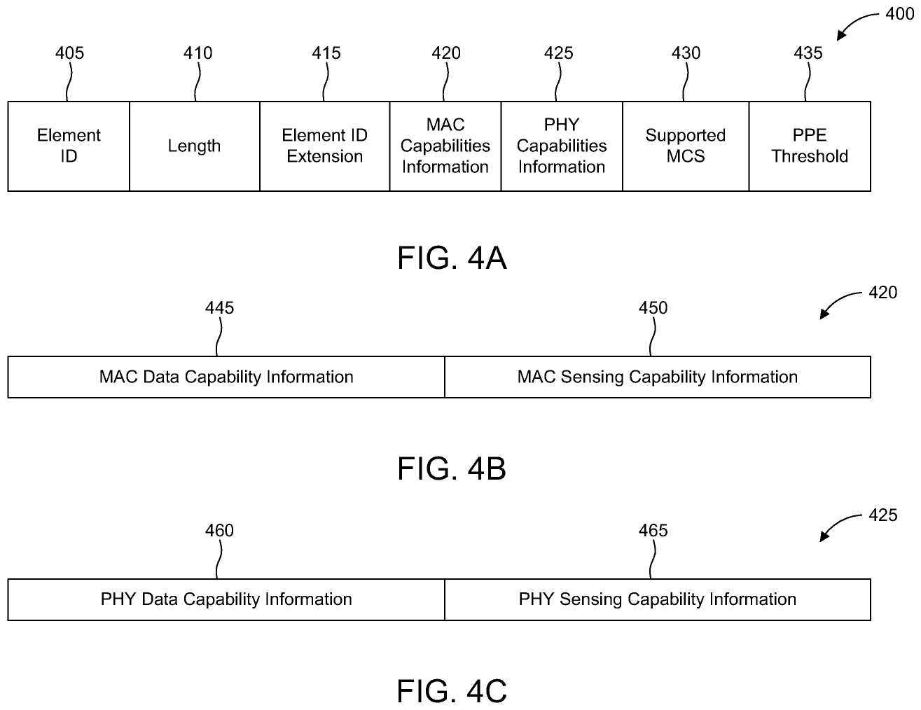

FIG. 4A illustrates an example format for a capabilities element 400 of a probe request frame. Capabilities element 400 includes an element ID field 405, length field 410, element ID extension 415, Medium Access Control (MAC) capabilities information field 420, physical layer (PHY) capability information field 425, supported MCS field 430, and PPE threshold field 435. It is noted that in some implementations, a capabilities element of a probe request frame may include more fields, a subset of these fields, and/or different fields.

FIG. 4B illustrates an example format for MAC capability information field 420 illustrated in FIG. 4A. MAC capability information field 420 includes a MAC data capability information subfield 445 and a MAC sensing capability information subfield 440. It is noted that in some implementations, a MAC capability information field may include more fields, a subset of these fields, and/or different fields. In some implementations, a MAC Sensing capability information subfield may indicate optional MAC features that a STA may support for the sensing function.

FIG. 4C illustrates an example format for the PHY capability element information field 455 illustrated in FIG. 4A. PHY capability information field 425 includes a PHY data capability information subfield 460 and a PHY sensing capability information subfield 465. It is noted that in some implementations, a PHY capability information field may include more fields, a subset of these fields, and/or different fields. In some implementations, a PHY Sensing capability information subfield indicates optional MAC features that a STA may support for the sensing function.

In some implementations, if a sensing initiator is sensing transmitter, the sensing initiator may send a probe request frame indicating the PHY sensing capabilities desired of the sensing responder (e.g., sensing bandwidth, sensing resolution, angle of arrival resolution, sensing SNR, field-of-view, etc.) to identify sensing responder receivers' sensing capabilities Rx. The capabilities element of the probe request frame is shown in FIGS. 4A, 4B, and 4C.

If a sensing responder is a sensing transmitter, the sensing responder transmitter may send a probe request frame indicating the PHY sensing capabilities (e.g., sensing bandwidth, sensing resolution, angle of arrival resolution, sensing SNR, field-of-view, etc.) to identify the sensing responder receivers' sensing capability. The capabilities element of the probe request frame is shown in 4A, 4B, and 4C.

Sensing responder receivers may send probe responses if the PHY sensing capabilities in the probe request frame matches with sensing responders receiver's PHY sensing capabilities.

If a sensing initiator is a sensing transmitter, then the sensing initiator may receive the probe response frame in the UL from the sensing responder receivers with sensing responder receivers' PHY sensing capabilities (e.g., sensing bandwidth, sensing resolution, angle of arrival resolution, sensing SNR, field-of-view, etc.)

If a sensing responder is a sensing transmitter, then the sensing initiator may receive the probe response frame in the UL from the sensing responder receivers with the sensing responder receivers' PHY sensing capabilities (e.g., sensing bandwidth, sensing resolution, angle of arrival resolution, sensing SNR, field-of-view, etc.)

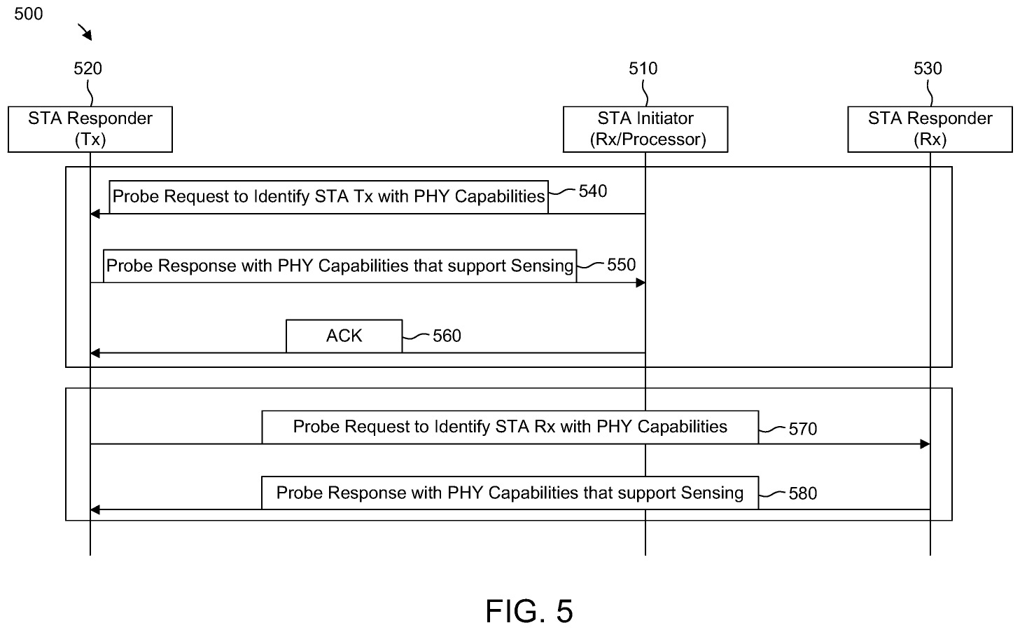

FIG. 5 is a message sequence chart which illustrates example signaling 500 for multi-STA assisted sensing (e.g., sensing-by-proxy) when one of sensing responders is a sensing transmitter while a sensing initiator is both receiver and processor.

Signaling 500 illustrates portions the establishment of a sensing session among STA sensing initiator receiver and processor 510, STA transmitter responder 520, and STA receiver responder 530.

In this context, STA sensing initiator receiver and processor 510 initiates the sensing session, in its role as sensing initiator. STA transmitter responder 520, and STA receiver responder 530 respond to the sensing initiator, in their role as sensing responders. STA sensing initiator receiver and processor 510 transmits a trigger frame or other suitable signal to sensing transmitter and sensing receiver devices to allocate resources for sensing, in its role as sensing processor. STA sensing initiator receiver and processor 510 also receives sensing measurement information from the sensing receivers and reports the sensing measurements, or information based on the sensing measurements (e.g., a sensing result), to the sensing initiator, in its role as sensing processor. STA transmitter responder 520 transmits a signal to be sensed (e.g., NDP, PPDU, or other suitable signal) during the sensing session in its role as sensing transmitter. STA sensing initiator receiver and processor 510, and STA receiver responder 530 report sensing measurements based on the received signal to be sensed (e.g., NDP, PPDU, or other suitable signal), in their role as sensing receivers.

In the particular example signaling 500, STA sensing initiator receiver and processor 510, transmits probe request 540 to STA transmitter responder 520. Probe request 540 includes information to identify sensor receivers having desired sensing capabilities (e.g. PHY sensing capabilities). For example, in some implementations, probe request 540 includes an indication of specific sensing capabilities.

STA transmitter responder 520 transmits probe response 550 to STA sensing initiator receiver and processor 510 in response to probe request 540. Probe response 550 indicates whether STA transmitter responder 520 has sensing capabilities matching the desired sensing capabilities and/or indicates which sensing capabilities, if any, STA transmitter responder 520 has.

STA sensing initiator receiver and processor 510 transmits acknowledgement (ACK) 560 to STA transmitter responder 520 in response to the probe response 550, to acknowledge receipt of probe response 550.

STA transmitter responder 520 transmits probe request 570 to STA receiver responder 530, responsive to receiving ACK 560. Probe request 570 includes information to identify sensor receivers having desired sensing capabilities (e.g. PHY sensing capabilities). For example, in some implementations, probe request 570 includes an indication of specific sensing capabilities.

STA receiver responder 530 transmits probe response 580 to STA transmitter responder 520 in response to probe request 570. Probe response 580 indicates whether STA receiver responder 530 has sensing capabilities matching the desired sensing capabilities and/or indicates which sensing capabilities, if any, STA receiver responder 530 has.

Some implementations provide sensing enhancement using NDPA and NDP transmissions, and examples are described herein.

For example, if a sensing initiator is a transmitter, then the sensing initiator may transmit an NDPA followed by an NDP. The NDPA frame may indicate the feedback type that sensing responder receiver is to respond with. The feedback type may include sensing measurement metrics such as time of flight (ToF), time difference of arrival (TDOA), full CSI, compressed CSI, angle of arrival, and/or other processed sensing signal information.

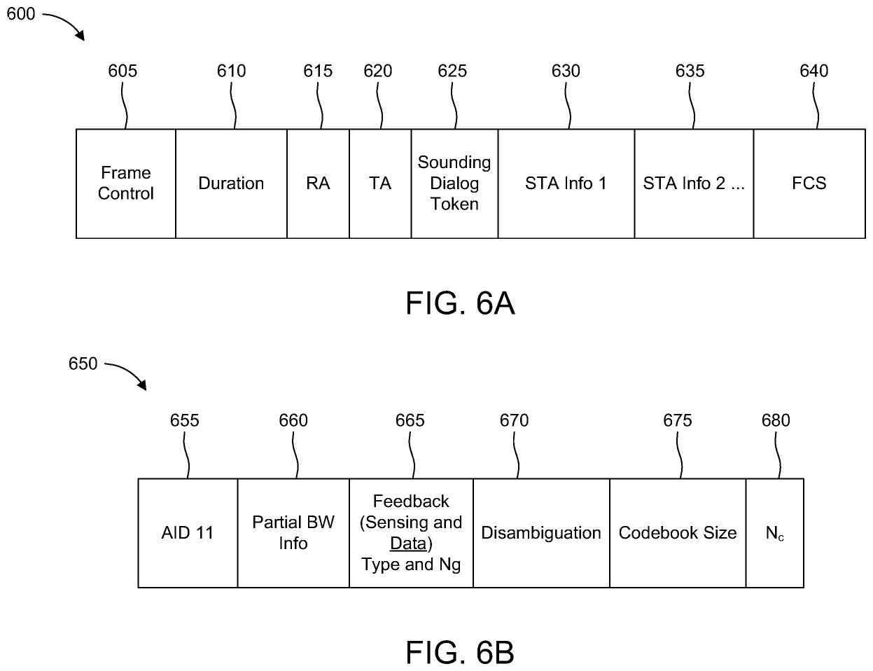

FIG. 6A illustrates an example NDPA frame 600. NDPA frame 600 includes a frame control field 605, duration field 610, receiver address (RA) field 615, transmitter address (TA) field 620, sounding dialog token field 625, STA info fields 630, 635 (there may be fewer than, or more than two STA info fields in some implementations), and frame check sequence (FCS) field 640. It is noted that in some implementations, a NDPA frame may include more fields, a subset of these fields, and/or different fields.

FIG. 6B illustrates an example STA info subfield 650 (e.g., STA info field 630 or 635 as in the NDPA frame illustrated in FIG. 6A). STA info field 650 includes an association identifier (AID 11) subfield 655, partial bandwidth (BW) info subfield 660, Feedback type (e.g., sensing and/or data feedback types) and Subcarrier grouping (Ng) subfield 655, disambiguation subfield 670, codebook size subfield 675, and Nc subfield 680. It is noted that in some implementations, a STA info field may include more subfields, a subset of these subfields, and/or different subfields.

The sensing feedback type requested by the sensing initiator may be different for different sensing responder transmitters (Tx). For example, the NDPA frame may include a different STA info field for each sensing responder transmitter, each indicating different sensing feedback types (e.g., in a subfield of the STA info field, such as a feedback type subfield).

In some implementations, a sensing initiator may also inform a sensing responder receiver of the trigger frame transmit address so that the sensing responder receiver knows the address of the sensing STA transmitting the trigger frame following the NDPA. This may be indicated via backhaul or wireless network, or in the NDPA format. Example sensing feedback types are shown in Table 1 below.

If a sensing responder is a transmitter, the sensing responder transmitter may transmit the NDPA followed by NDP. The NDPA frame may indicate the feedback type (e.g., as described above) that the sensing responder receiver is to respond with.

In some implementations, the sensing responder transmitter may also inform the sensing responder receiver of a trigger frame transmit address of the sensing STA transmitting the trigger frame following the NDPA. This may be indicated, for example, via backhaul or wireless network, or in the NDPA format.

In some implementations, the desired sensing feedback type may be included in a feedback type subfield, e.g., STA info field 650 as shown and described with respect to FIG. 6B.

In some implementations, the Feedback type And Ng subfield and codebook size subfield of the STA info field may be encoded together using multiple bits (e.g., 3 bits in 802.11ax). In some implementations, if the subfields (i.e. Feedback type An NG subfield and codebook size subfield, shown in FIG. 6B) are increased to 4 bits, sensing measurements specific feedback types of up to 8 may be indicated. In some implementations, one or more reserved bits of the STA info subfield in the NDPA frame (e.g., when AID11 is 2047, as in 802.11ax) may be used for this purpose.

TABLE 1

| | |
|---|---|
| 0 | Time of flight (ToF) |
| 1 | Time difference of arrival (TDOA) |
| 2 | Angle of arrival (AoA) |
| 3 | Full channel state info (full CSI) |
| 4 | Compressed CSI |
| 5 | Received signal strength (RSS) |
| 6 | Location, mobility |
| 7 | Processed information |

Some implementations include trigger frame transmissions, and examples are described herein. For example, in an implementation where the sensing initiator is the sensing processor, the sensing initiator may send a trigger frame to the sensing responder receivers, where the sensing initiator may indicate resources (e.g., the resource unit, frame variant in the UL) for the sensing responder receiver to use in reporting sensing measurements.

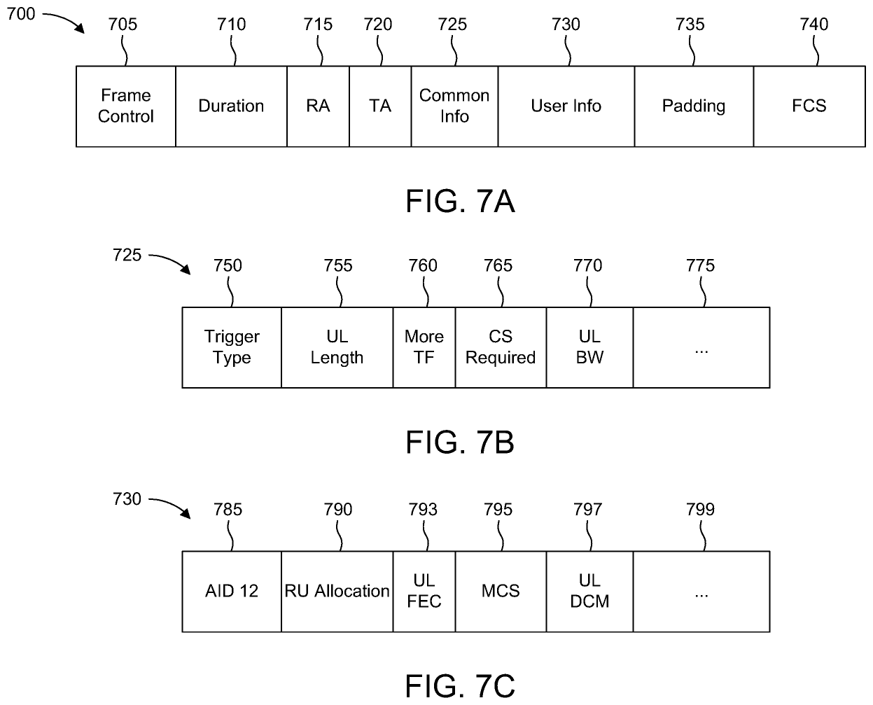

FIG. 7A illustrates an example trigger frame 700. Trigger frame 700 includes a frame control field 705, duration field 710, receiver address (RA) field 715, transmitter address (TA) field 720, common information field 725, user information field 730, padding field 735, and FCS field 740. It is noted that in some implementations, a trigger frame may include more fields, a subset of these fields, and/or different fields.

FIG. 7B illustrates further detail of example common information field 725, as shown and described with respect to FIG. 7A). Common information field 745 includes a trigger type subfield 750, uplink (UL) length subfield 755, more TF subfield 760, channel sensing (CS) required subfield 765, UL BW subfield 770, and possible additional subfields 775. It is noted that in some implementations, a common information field may include more subfields, a subset of these subfields, and/or different subfields.

FIG. 7C illustrates further detail of example user information field 730, as shown and described with respect to FIG. 7A. User information field 730 includes AID12 subfield 785, RU allocation subfield 790, UL FEC subfield 793, MCS subfield 795, UL DCM subfield 797, and possible additional subfields 799. It is noted that in some implementations, a user information field may include more subfields, a subset of these subfields, and/or different subfields.

If a sensing responder (e.g., a sensing responder transmitter (Tx) or a sensing responder receiver (Rx)) is also the sensing processor, then the sensing responder may send a trigger frame to the other sensing responder receivers. The trigger frame may indicate the resource unit and/or frame variant in the UL for the sensing responder receiver to report sensing measurements or information based on the sensing measurements.

Some implementations include sensing measurements. For example, in some implementations, some or all sensing responder receivers may feed back sensing measurements, or information based on sensing measurements, to the sensing STA whose address is configured in the trigger frame.

In some implementations, the sensing measurements that are taken and/or fed back may be based on a feedback type received by the sensing receiver, e.g., as in step 330 as shown and described with respect to FIG. 3. For example, in some implementations, a feedback type may be indicated in an NDPA frame and/or a STA info subfield (e.g., as shown and described with respect to FIG. 6B). Example sensing measurement types for sensing are indicated in Table 1.

In some implementations, sensing responder receivers may compute the required sensing measurements (e.g., CSI/compressed CSI/TDOA/RSS), e.g., upon or based on receiving an NDP. Example sensing measurement types are indicated in Table 1.

Some implementations include determining and/or providing a sensing result. For example, in some implementations, if a sensing initiator (e.g., a sensing transmitter (Tx) or a sensing receiver (Rx)) includes a sensing processor, the sensing initiator/processor may receive sensing measurements from all sensing responder receivers, and in its role as sensing processor, may generate a sensing result based on the received sensing measurements. In some implementations, the session may be terminated after the sensing result is generated.

In some implementations, if the sensing responder (e.g., a sensing transmitter (Tx) or a sensing receiver (Rx)) includes a sensing processor, the sensing responder may receive sensing measurements from all other sensing responder receivers, and in its role as sensing processor, may generate a sensing result based on the received sensing measurements. In some implementations, the sensing result (and/or sensing measurements) may be fed back to the sensing initiator. In some implementations, the session may be terminated after the sensing result (and/or sensing measurements) is fed back to the sensing initiator.

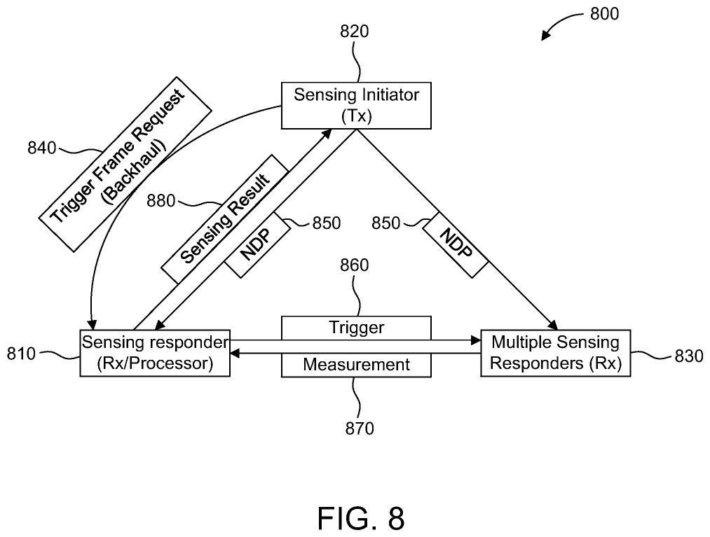

FIG. 8 is a system diagram 800 illustrating an example scenario where a sensing responder 810 is both a sensing receiver and a sensing processor. This example scenario illustrates a sensing session among sensing responder, receiver, and processor 810, sensing initiator transmitter 820, and sensing responder receiver 830. In this example, responder receiver 830 represents a plurality of responder receivers.

Sensing initiator transmitter 820 transmits a trigger frame request 840 to sensing responder, receiver, and processor 810. In this example, trigger frame request 840 is or is included in an NDPA, which is transmitted over a backhaul connection, however in some implementations, the request may be transmitted in a different format or over a different medium.

After transmitting trigger frame request 840, sensing initiator transmitter 820 transmits an NDP 850 to sensing responder, receiver, and processor 810 and sensing responder receiver(s) 830, and sensing responder, receiver, and processor 810 transmits trigger frame 860 to sensing responder receiver(s) 830. Sensing responder receiver(s) 830 and sensing responder, receiver, and processor 810 take measurements of the NDP 850 (e.g., based on a feedback type indicated in trigger frame request 840). Sensing responder receiver(s) 830 report the measurements 870 (or information based on the measurements) to sensing responder, receiver, and processor 810, e.g., on transmission resources allocated by trigger frame 860. Sensing responder, receiver, and processor 810 generates a sensing result 880 based on the measurements 870 as well as its own measurements, and transmits sensing result 880 to sensing initiator transmitter 820.

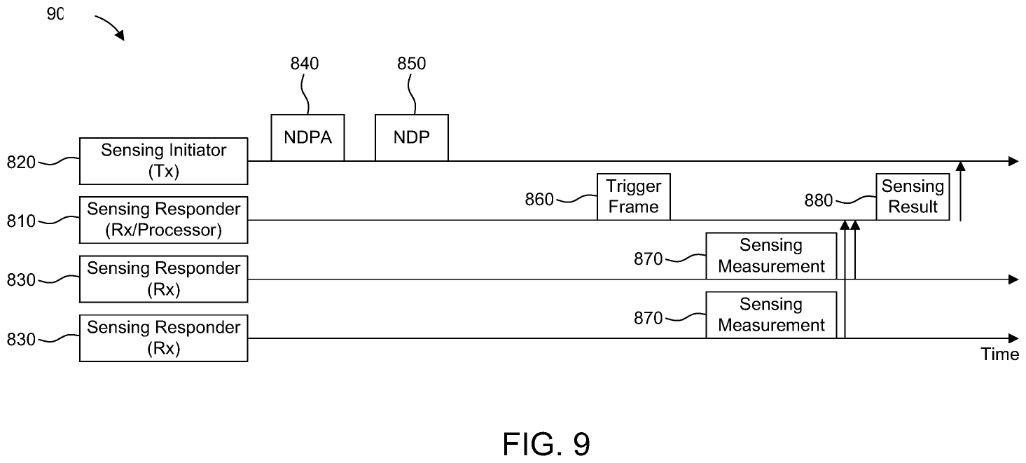

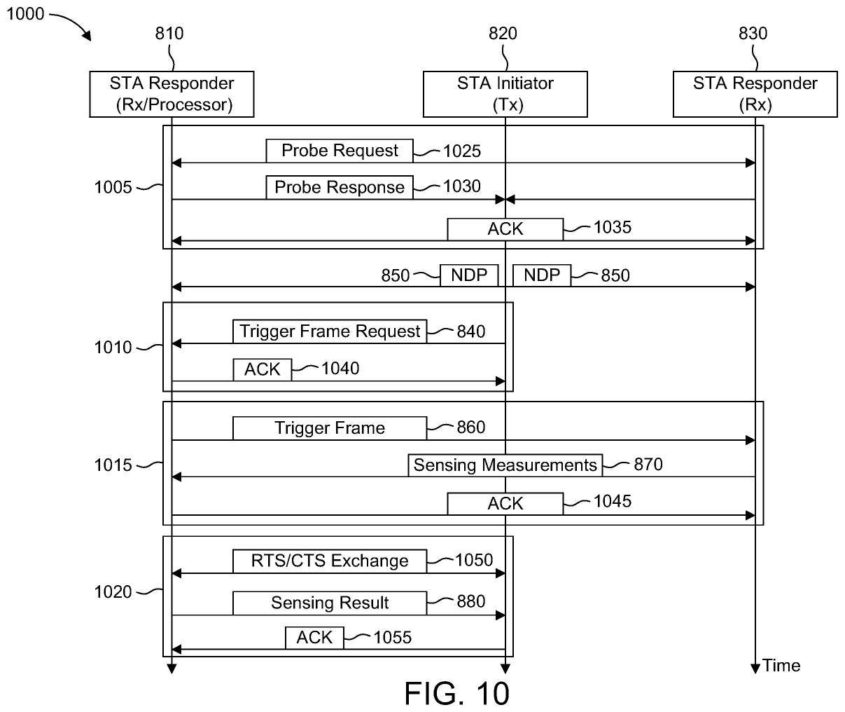

FIG. 9 is a signaling diagram 900 which further illustrates the messaging shown and described with respect to FIG. 8. FIG. 10 is a message sequence chart 1000 which illustrates the messaging shown and described with respect to FIGS. 8 and 9, in further context. Message sequence chart 1000 includes signaling which may be referred to as including a probe phase 1005, trigger frame request phase 1010, measurement and reporting phase 1015, and sensing result reporting phase 1020. Signaling is organized into these phases are indicated simply for the purpose of description, and in some implementations, the signaling is not organized into these or any other phases.

In probe phase 1005, sensing initiator transmitter 820 transmits a probe request 1025 to sensing responder, receiver, and processor 810, and sensing responder receiver(s) 830, receives a probe response 1030 from sensing responder, receiver, and processor 810, and sensing responder receiver(s) 830, and transmits an acknowledgement (ACK) 1035 of the probe response 1030 to sensing responder, receiver, and processor 810 and sensing responder receiver(s) 830. In some implementations, the signaling of probe phase 1005 corresponds to steps 310 and 320 as shown and described with respect to FIG. 3. After transmitting ACK 1035, sensing initiator transmitter 820 transmits NDP 850 to sensing responder, receiver, and processor 810 and sensing responder receiver(s) 830. In some implementations the signaling of NDP 850 corresponds to step 330 as shown and described with respect to FIG. 3.

In trigger frame request phase 1010, sensing initiator transmitter 820 transmits trigger frame request 840 to sensing responder, receiver, and processor 810, and receives ACK 1040 in return. In this example, trigger frame request 840 is transmitted over a backhaul connection, however in some implementations, the request may be transmitted in a different format or over a different medium. In some implementations the signaling of trigger frame request 840 also corresponds to step 330 as shown and described with respect to FIG. 3.

In measurement and reporting phase 1015, sensing responder, receiver, and processor 810 transmits trigger frame 860 to sensing responder receiver(s) 830. Sensing responder receiver(s) 830 and sensing responder, receiver, and processor 810 take measurements (e.g., based on a feedback type indicated in trigger frame request 840). Sensing responder receiver(s) 830 report the measurements 870 (or information based on the measurements) to sensing responder, receiver, and processor 810, e.g., on transmission resources allocated by trigger frame 860. Sensing responder, receiver, and processor 810 transmits an ACK 1045 in response to sensing responder receiver(s) 830.

In sensing result reporting phase 1020, sensing responder, receiver, and processor 810 and sensing initiator transmitter 820 may exchange RTS and CTS frames 1050, e.g., in order to acquire the medium such that a legacy STA may report the sensing measurements. Sensing responder, receiver, and processor 810 generates a sensing result 880 based on the measurements 870 as well as its own measurements, and transmits sensing result 880 to sensing initiator transmitter 820. Sensing initiator transmitter 820 transmits an ACK 1055 in response to sensing responder, receiver, and processor 810.

It is noted that a sensing initiator may be a receiver as well as a processor, wherein a sensing responder (Tx) may send NDPA and multi-user (MU) sensing responders (Rx) may receive NDP as illustrated in FIG. 8.

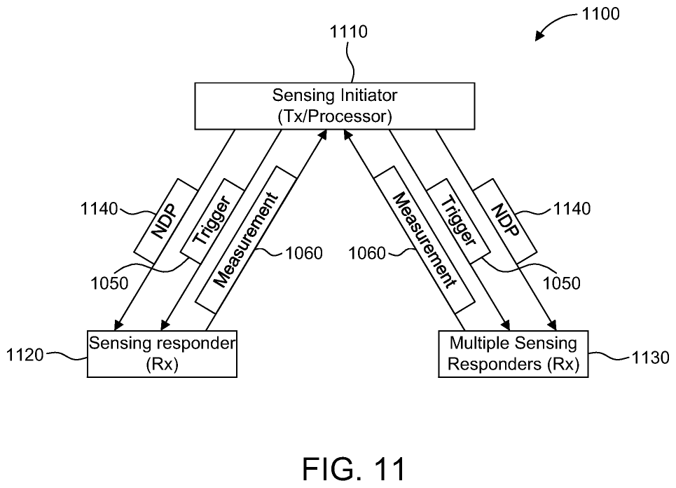

FIG. 11 is a system diagram 1100 illustrating an example scenario where a sensing initiator is both a sensing transmitter and a sensing processor. This example scenario illustrates a sensing session among sensing initiator, transmitter, and processor 1110, sensing responder and receiver 1120, and sensing responder and receiver 1130. In this example, responder receiver 1130 represents a plurality of responder receivers. It is noted that, alternatively, sensing responder and receiver 1120 could be illustrated as part of the group of responder receivers 1130.

Sensing initiator, transmitter, and processor 1110 transmits an NDP 1140 to sensing responder and receiver 1120, and sensing responder and receiver 1130. It is noted that since sensing initiator, transmitter, and processor 1110 is the sensing processor, it does not need to first receive a trigger frame request as in the example of FIGS. 8, 9, and 10.

After transmitting NDP 1140, sensing initiator, transmitter, and processor 1110 transmits a trigger frame 1150 to sensing responder and receiver 1120, and sensing responder and receiver 1130.

Sensing responder and receiver 1120, and sensing responder and receiver 1130 take measurements (e.g., based on a feedback type indicated in an earlier NDPA, not shown). Sensing responder and receiver 1120, and sensing responder and receiver 1130 report the measurements 1160 (or information based on the measurements) to sensing initiator, transmitter, and processor 1110, e.g., on transmission resources allocated by trigger frame 1150. It is noted that since sensing initiator, transmitter, and processor 1110 is the sensing processor, it does not need to report a sensing result based on the measurements 1160, although it may generate a sensing result in some implementations.

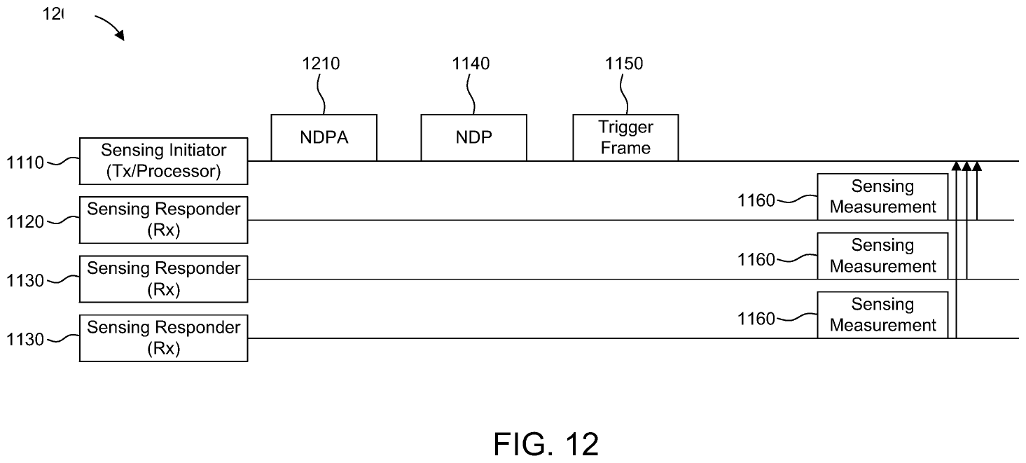

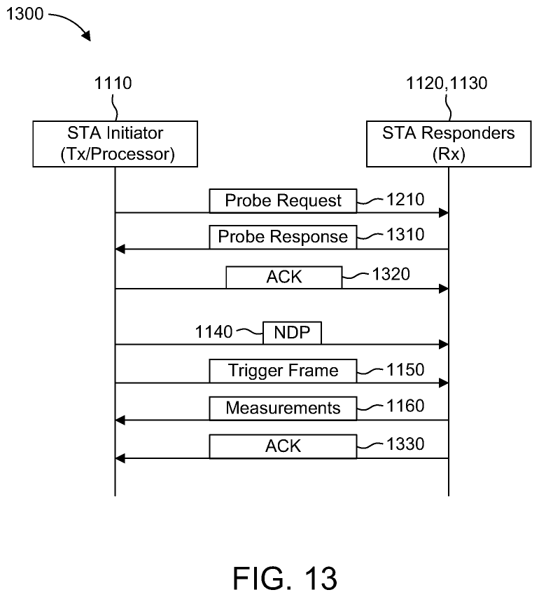

FIG. 12 is a signaling diagram 1200 which further illustrates the messaging shown and described with respect to FIG. 11, also illustrating NDPA 1210. FIG. 13 is a message sequence chart 1300 which illustrates the messaging shown and described with respect to FIGS. 11 and 12, in further context. Sensing initiator, transmitter, and processor 1110 transmits NDPA 1210 to sensing responder and receivers 1120, 1130. Sensing initiator, transmitter, and processor 1110 receives a probe response 1310 in return from sensing responder and receivers 1120, 1130. Sensing initiator, transmitter, and processor 1110 transmits an acknowledgement (ACK) 1320 of the probe response 1310 to sensing responder and receivers 1120, 1130. In some implementations the probe signaling corresponds to steps 310 and 320 as shown and described with respect to FIG. 3.

After transmitting ACK 1320, sensing initiator, transmitter, and processor 1110 transmits NDP 1140 to sensing responder and receivers 1120, 1130. In some implementations the signaling of NDP 1140 corresponds to step 330 as shown and described with respect to FIG. 3.

Sensing initiator, transmitter, and processor 1110 transmits trigger frame 1150 to sensing responder and receivers 1120, 1130, which take measurements (e.g., based on a feedback type indicated in NDPA 1210). Sensing responder and receivers 1120, 1130 report the measurements 1160 (or information based on the measurements) to sensing initiator, transmitter, and processor 1110, e.g., on transmission resources allocated by trigger frame 1150. Sensing responder and receivers 1120, 1130 transmit an ACK 1045 in response to sensing initiator, transmitter, and processor 1110.

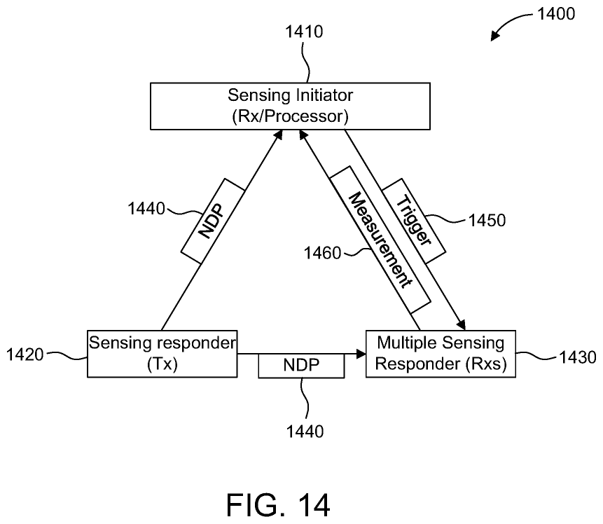

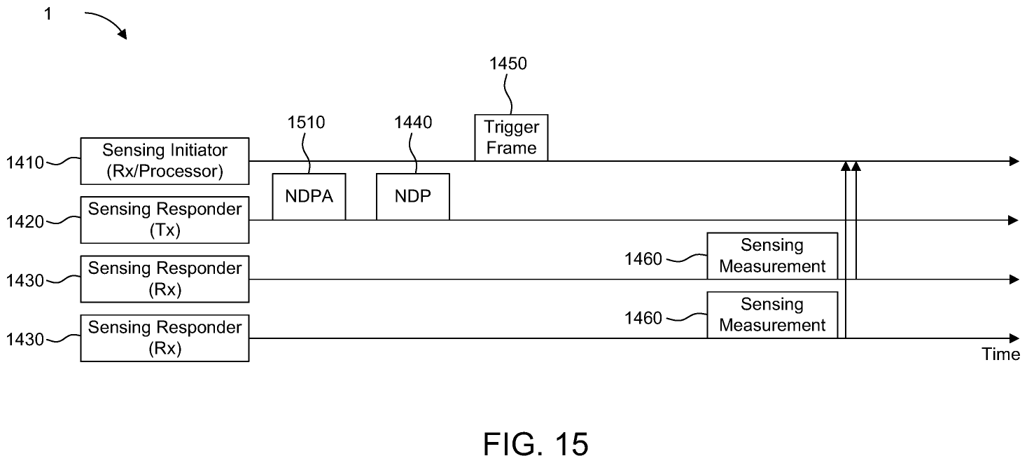

FIG. 14 is a system diagram 1400 illustrating an example scenario where a sensing initiator is both a sensing receiver and a sensing processor. This example scenario illustrates a sensing session among sensing initiator, receiver, and processor 1410, sensing responder and transmitter 1420, and sensing responder and receiver 1430. In this example, responder receiver 1430 represents a plurality of sensing responder receivers.

Sensing responder and transmitter 1420 transmits an NDP 1440 to sensing initiator, receiver, and processor 1410, and sensing responder and receivers 1430.

After transmitting NDP 1440, sensing initiator, receiver, and processor 1410 transmits a trigger frame 1450 to sensing responder and receivers 1430.

Sensing responder and receivers 1430 take measurements (e.g., based on a feedback type indicated in an earlier NDPA, not shown). Sensing responder and receivers 1430 report the measurements 1460 (or information based on the measurements) to sensing initiator, receiver, and processor 1410, e.g., on transmission resources allocated by trigger frame 1450.

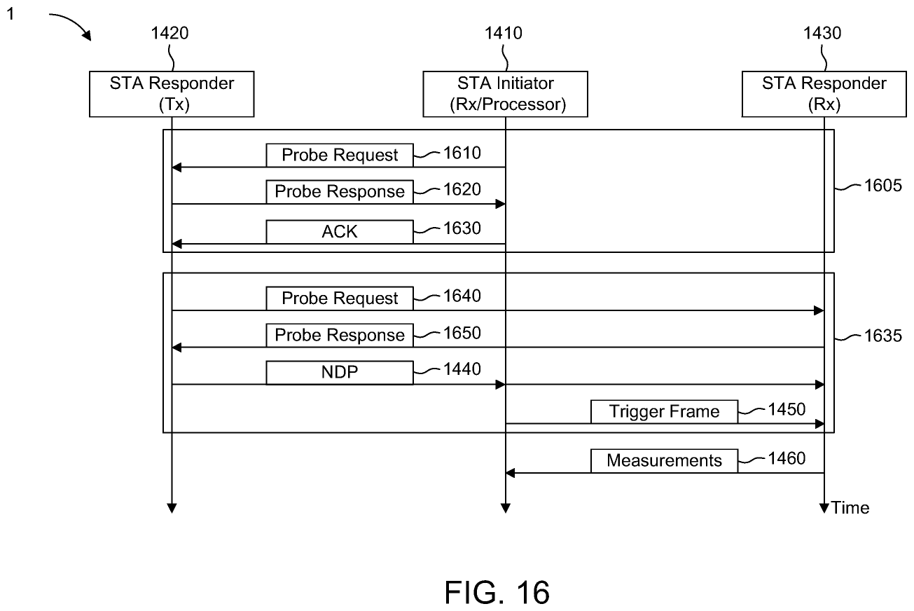

FIG. 15 is a signaling diagram 1500 which further illustrates the messaging shown and described with respect to FIG. 14, also illustrating NDPA 1510. FIG. 16 is a message sequence chart 1600 which illustrates the messaging shown and described with respect to FIGS. 14 and 15, in further context.

In probe phase 1605, sensing initiator, receiver, and processor 1410 transmits probe request 1610 to sensing responder and transmitter 1420. Sensing initiator, receiver, and processor 1410 receives probe response 1620 from sensing responder and transmitter 1420. Sensing initiator, receiver, and processor 1410 transmits ACK 1630 to sensing responder and transmitter 1420.

In probe phase 1635, sensing responder transmitter 1420 transmits a probe request 1640 to sensing responder and receivers 1430. Sensing responder transmitter 1420 receives a probe response 1650 in return from sensing responder and receivers 1430. Sensing responder transmitter 1420 transmits NDP 1440 to sensing initiator, receiver, and processor 1410. Sensing initiator, receiver, and processor 1410 transmits trigger frame 1450 to sensing responder and receivers 1430.

Sensing responder and receivers 1430 take measurements 1460 and report the measurements 1460 (or information based on the measurements) to sensing initiator, receiver, and processor 1110, e.g., on transmission resources allocated by trigger frame 1450.

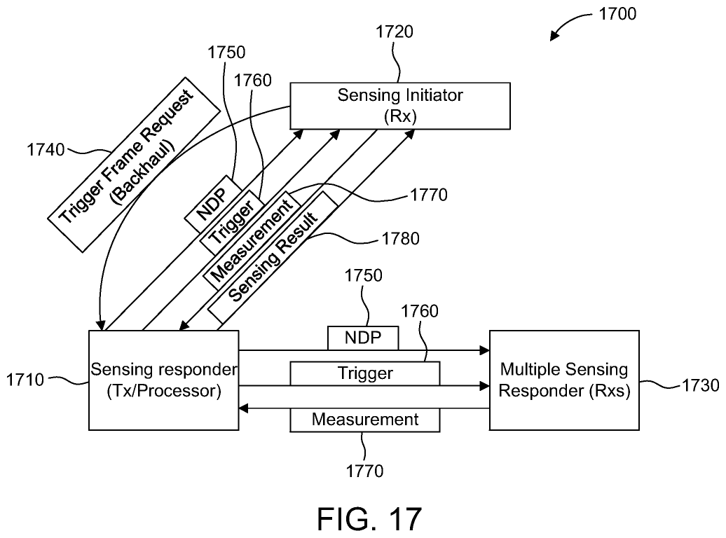

FIG. 17 is a system diagram 1700 illustrating an example scenario where a sensing responder 1710 is both a sensing transmitter and a sensing processor. This example scenario illustrates a sensing session among sensing responder, transmitter, and processor 1710, sensing initiator receiver 1720, and sensing responder receiver 1730. In this example, sensing responder receiver 1730 represents a plurality of responder receivers.

Sensing initiator receiver 1720 transmits a trigger frame request 1740 to sensing responder, transmitter, and processor 1710. In this example, trigger frame request 1740 is or is included in an NDPA, which is transmitted over a backhaul connection, however in some implementations, the request may be transmitted in a different format or over a different medium.

After transmitting trigger frame request 1740, sensing initiator transmitter 1720 and sensing responder receiver(s) 1730 receive an NDP 1750 from sensing responder, transmitter, and processor 1710, and sensing initiator transmitter 1720 and sensing responder receiver(s) 1730 receive trigger frame 1760 from sensing responder, transmitter, and processor 1710. Sensing responder receiver(s) 1730 and sensing initiator receiver 1720 take measurements 1770 of NDP 1750 (e.g., based on a feedback type indicated in trigger frame request 1760), and report the measurements 1770 (or information based on the measurements) to sensing responder, transmitter, and processor 1710, e.g., on transmission resources allocated by trigger frame 1760. Sensing responder, transmitter, and processor 1710 generates a sensing result 1780 based on the measurements 1770, and transmits sensing result 1780 to sensing initiator receiver 1720.

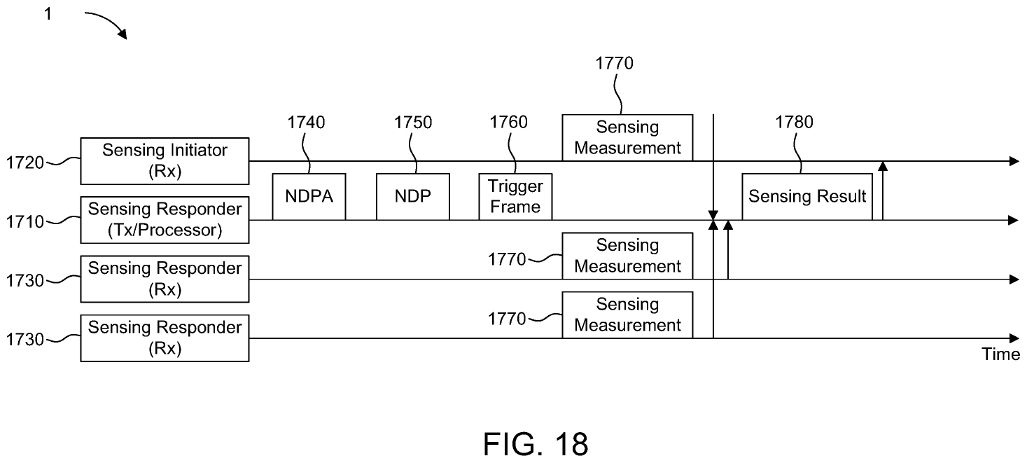

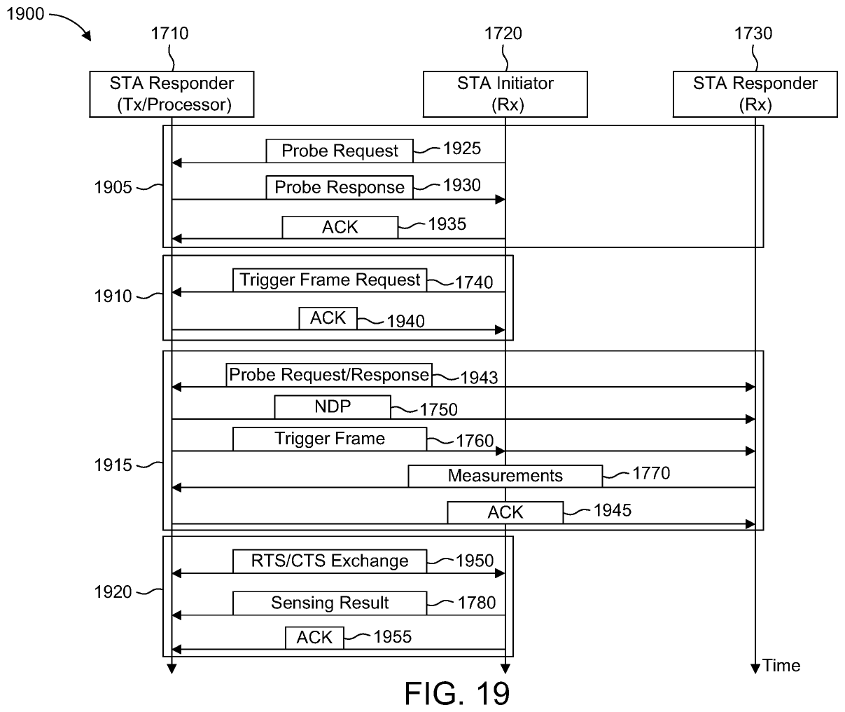

FIG. 18 is a signaling diagram 1800 which further illustrates the messaging shown and described with respect to FIG. 17. FIG. 19 is a message sequence chart 1900 which illustrates the messaging shown and described with respect to FIGS. 17 and 18, in further context.

Message sequence chart 1900 includes signaling which may be referred to as including a probe phase 1905, trigger frame request phase 1910, measurement and reporting phase 1915, and sensing result reporting phase 1920. Signaling is organized into these phases are indicated simply for the purpose of description, and in some implementations, the signaling is not organized into these or any other phases.

In probe phase 1905, sensing initiator receiver 1720 transmits a probe request 1925 to sensing responder, transmitter, and processor 1910, receives a probe response 1930 from sensing responder, transmitter, and processor 1710, and transmits an acknowledgement (ACK) 1935 of the probe response 1930 to sensing responder, transmitter, and processor 1710. In some implementations the signaling of probe phase 1905 corresponds to steps 310 and 320 as shown and described with respect to FIG. 3.

In trigger frame request phase 1910, sensing initiator receiver 1720 transmits trigger frame request 1740 to sensing responder, transmitter, and processor 1710, and receives ACK 1940 in return. In this example, trigger frame request 1740 is transmitted over a backhaul connection, however in some implementations, the request may be transmitted in a different format or over a different medium. In some implementations the signaling of trigger frame request 1740 also corresponds to step 330 as shown and described with respect to FIG. 3.

In measurement and reporting phase 1915, sensing initiator receiver 1720 transmits a Probe request/response 1943 to sensing responder, receiver, and processor 1710 and sensing responder receiver(s) 1730. sensing responder, receiver, and processor 1710 transmits NDP 1750 to sensing responder receiver(s) 1730. Sensing responder, receiver, and processor 1710 transmits trigger frame 1760 to sensing responder receiver(s) 1730 and sensing initiator receiver 1720. Sensing responder receiver(s) 1730 and sensing initiator receiver 1720 take measurements of NDP 1750. Sensing responder receiver(s) 1730 and sensing initiator receiver 1720 report the measurements 1770 (or information based on the measurements) to sensing responder, transmitter, and processor 1710, e.g., on transmission resources allocated by trigger frame 1760. Sensing responder, transmitter, and processor 1710 transmits an ACK 1945 in response to sensing responder receiver(s) 830.

In sensing result reporting phase 1920, sensing responder, transmitter, and processor 1710 and sensing initiator receiver 1720 exchange RTS and CTS frames 1950 to confirm that the channel is free. Sensing initiator receiver 1720 generates a sensing result 1780 based on the measurements 1770 as well as its own measurements, and transmits sensing result 1780 to sensing initiator transmitter 1720. Sensing initiator receiver 1720 transmits an ACK 1955 in response to sensing responder, transmitter, and processor 1710.

It is noted that a sensing initiator may be a transmitter only, wherein MU sensing responder Rx may receive the NDPA and feedback the sensing measurements to the sensing responder Rx which is also a processor. The sensing responder (Rx/processor) may feedback the sensing result to the sensing initiator, as illustrated in FIG. 17.

Some implementations include dynamic and/or multiple sensing feedback types.

For example, In some implementations, a sensing initiator may identify one or multiple sensing feedback types during the sensing session set up phase (i.e., during exchange of beacon and probe request, prior to sensing), depending on the application requirements. For example, in some implementations, the sensing initiator may identify sensing feedback types dynamically during a sensing session depending on the sensing application requirements in real time.

In some implementations, a sensing initiator may send identified sensing feedback types to sensing responder transmitters. In some implementations, the sensing feedback type may be a single sensing feedback type, or multiple sensing feedback types. For example, in some implementations, a sensing initiator may send a sensing feedback type to a sensing responder transmitter dynamically during the sensing session. In some implementations, this is done because the sensing roles of a specific STA may change during the sensing session. In this example, a STA acting as sensing responder transmitter may change roles. In this scenario, the sensing initiator may dynamically inform the STA acting as sensing responder transmitter of the sensing feedback type, (e.g. in a round robin fashion, or sequential in time) at the specific turn in time during the sensing session.

In some implementations, a sensing initiator may not necessarily identify all possible sensing feedback types (e.g., CSI/RSS/ToF/Doppler etc.) that may be required during a sensing session. In some implementations, a sensing initiator may dynamically identify the sensing feedback type or types required depending on the sensing application (e.g., where different applications require different types of feedback).

In some implementations, a sensing initiator may dynamically send a probe request frame that includes a sensing feedback type (e.g. Doppler or CSI) capability to solicit a probe response frame from potential sensing responder transmitters. In some implementations, the probe response frame includes sensing feedback type capability information (e.g., Doppler or ToF).

In some implementations, this sensing feedback type required by the sensing initiator may also or alternatively be indicated using a data frame. In some implementations the sensing responder transmitter may respond with ACK or NACK to the sensing feedback type request.

In some implementations a potential sensing responder transmitter may send a probe response frame to the sensing initiator if the sensing capability of the potential sensing responder transmitter matches with the sensing feedback type in the probe request frame sent by the sensing initiator. For example, if the sensing feedback type required by the sensing initiator is indicated as Doppler in the probe request frame, the potential sensing responder transmitter may check its sensing capability and respond to the sensing initiator with a probe response frame.

In some implementations, depending on the sensing feedback type, the sensing responder transmitter may have different resources allocated (e.g., length of preamble, pilots, etc.) in either time or frequency domain to obtain channel state information estimation for sensing. For example, in some implementations, a large number of pilots may be required for high range resolution and/or a large number of time observations (pilots) may be required for high resolution Doppler. Accordingly, depending on the sensing feedback type, the pilot density and/or structure may be varied by the sensing responder transmitter.

In some implementations, the sensing responder transmitter may indicate the feedback type to the sensing responder receiver. In some implementations, the sensing responder receivers are identified similarly using during the sensing session (e.g., using an NDPA frame). For example, in some implementations, a sensing initiator may send “sensing feedback type fi” to “potential sensing responder transmitter i” using probe request frame at “time Ti” where Ti is the time slot of the STA ‘i’ acting as sensing responder transmitter i.

In some implementations, a sensing initiator may indicate a sensing feedback type (e.g., CSI, RSS, ToF, and/or range resolution, etc.) to sensing responder transmitters that are identified during the set-up phase. In this scenario, in some implementations, the sensing initiator may request different sensing feedback types for different sensing responder transmitters during the set-up phase.

In some implementations, a sensing initiator may send a probe request frame that indicates a sensing feedback type (e.g., Doppler or CSI) capability to solicit probe response frames from potential sensing responder transmitters during the set-up phase. In some implementations, the probe response frame includes or indicates the sensing feedback type capability information (e.g., Doppler or ToF).

In some implementations, the sensing feedback type required by the sensing initiator may also or instead be indicated using a data frame. The sensing responder transmitter may respond with ACK or NACK to the sensing feedback type request. For example, sensing initiator may send “sensing feedback types f1, f2, . . . , fn” to “potential sensing responder Txs Tx1, Tx2, . . . , Txn” using a probe request frame before the sensing session, e.g., during the sensing set-up phase.

In some implementations, during the sensing session, the STA acting as a sensing responder transmitter in the respective time slot Ti of the sensing session may indicate the respective feedback type to the sensing responder Rx during the specific slot of the sensing session (e.g., using an NDPA frame).

In some implementations, the sensing responder transmitter may indicate a sensing feedback type (i.e., feedback type requested by sensing initiator) to the sensing responder receiver using an NDPA frame. In some implementations, a new sensing NDPA frame may be used, e.g., which includes a sensing information subfield in a STA info field as shown in Table 2.

TABLE 2

| | | | | | |
|---|---|---|---|---|---|
| AID11 | Partial | Feedback | Disambiguation | Codebook | N_{c} |
| | BW info | (sensing and/ | | size | |
| | | or data) | | | |
| | | Type and Ng | | | |

In some implementations, a MAC header of the NDPA frame may be used to indicate the frame type, e.g., so that legacy devices such as VHT/HE/AZIEHT may identify that the frame type is for sensing. In some implementations, whether the NDPA is a sensing NDPA or a regular NDPA is indicated in a new field, such as a sounding and/or sensing sequence field. Table 3 shows an example NDPA frame MAC header, e.g., for this purpose.

TABLE 3

| | | | | | | | | |
|---|---|---|---|---|---|---|---|---|
| Frame | Dura- | RA | TA | Sounding/ | STA | . . . | STA | FCS |
| Control | tion | | | Sensing | Info 1 | | Info n | |
| | | | | Sequence | | | | |

Some implementations include sensing measurement based on implicit sounding schemes.

In some implementations, the channel variation of a testing signal is measured between one or more transmitters and one or more receivers, e.g., in order to sense activity in an environment. For example, in some implementations, the channel may be measured between one or more APs and one or more STAs (e.g., in either direction).

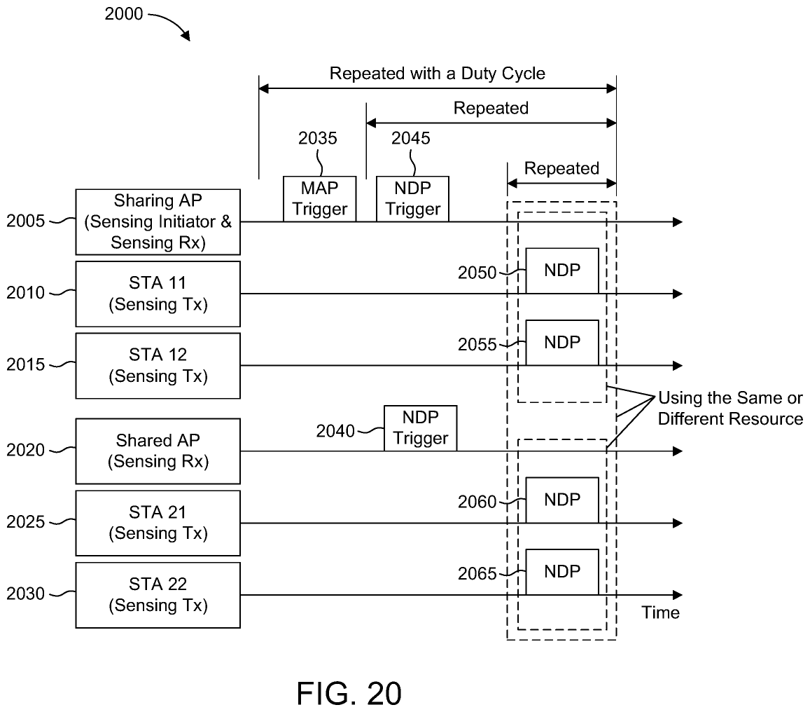

FIG. 20 is a signaling chart which illustrates an example sensing procedure 2000 based on UL channel information with multiple APs. Sensing procedure 2000 takes place among a sharing AP 2005, STA1 1 2010, STA2 2 2015, shared AP 2020, STA 2 1 2025, and STA 2 2 2030.

In this example, sharing AP 2005 first obtains a TXOP, sets a network allocation vector (NAV), and shares the duration of the TXOP with another AP (shared AP 2020 in this example) for multi-AP transmission schemes. The sharing AP 2005, acting as a Multi-AP sensing initiator, sends a Multi-AP (MAP) trigger 2035 to shared AP 2020. Shared AP 2020 transmits NDP trigger frames simultaneously with sharing AP 2005 based on MAP trigger 2035. In this example, shared AP 2020 transmits NDP trigger 2040 simultaneously with NDP trigger 2045 transmitted by sharing AP 2005, based on MAP trigger 2035.

In general, NDP trigger frames are transmitted from an AP to instruct associated STAs, acting as sensing transmitters to send NDP frames in the UL direction simultaneously. In this example, sensing.

STA1 1 2010, STA2 2 2015, STA2 1 2025, and STA2 2 2030 transmit NDP frames 2050, 2055, 2060, and 2065 simultaneously, based on NDP triggers 2045 and 2040.

When STA1 1 2010, STA2 2 2015, STA2 1 2025, and STA 2 2 2030, acting as sensing transmitters, send NDP frames 2050, 2055, 2060, and 2065, the sharing AP 2005 and shared AP 2020, acting as sensing receivers, may measure the UL channels individually among different AP-STA (sensing Tx-Rx) links, combinedly between an AP (sensing Rx) and multiple STAs (sensing Txs), or partially combined, depending on a resource usage setting, In some implementations, the resource includes frequency, time, code, and/or other resources.

As shown in FIG. 20, sensing transmitter STAs repeat NDP transmissions a number of times for each received NDP trigger. In some implementations, the number of NDP transmission repeats may be indicated in the NDP trigger. Sensing initiator APs repeat NDP trigger transmissions a number of times for each received MAP trigger. In some implementations, the number of NDP trigger transmission repeats may be indicated in the MAP trigger.

In general, a MAP Trigger (e.g., MAP trigger 2035) may carry the following information: (1) a shared AP ID for participation in channel measurements; (2) resources and bandwidth on which to transmit MAP trigger frames; (3) an indication of resources and bandwidth to be measured; (4) an indication of a number of times the NDP trigger should be repeated per MAP trigger; (5) an indication of a number of NDPs repeated per NDP trigger; and/or (6) an indication of a channel measurement type (e.g., an indication that feedback will indicate compressed or non-compressed Channel State Information, Doppler, time of flight (ToF), a time difference of arrival (TDOA), an angle of arrival (AoA), received signal strength (RSS), etc.). In some implementations, a MAP trigger (e.g., MAP trigger 2035) may also include an indication of a measurement parameter (e.g., an indication of a feedback resolution and/or an indication of a feedback accuracy).

In general, an NDP Trigger (e.g., NDP trigger 2040, 2045) may carry the following information: (1) an indication of resources to be used for NDP transmission for each of its associated STAs (e.g., in some implementations, resources used for transmitting the NDP in UL for all or some STAs may be the same); (2) an indication of length or padding of the NDP packet; (3) an indication of a number of repeating transmissions of NDP from each STA; (4) an indication of a numerology (e.g., subcarrier spacing) for NDP signals; (5) an indication of the IDs of STAs, or group IDs of a set of STAs, that are to transmit NDPs; and/or (6) an indication of an order of NDP transmissions from the STAs or STA groups that are to transmit NDPs.

After STAs complete their transmission of NDPs, each AP (e.g., sharing AP 2005 and shared AP 2020) may measure the channel and generate a measurement based on the indicated measurement type (e.g., as indicated in the MAP trigger). In some implementations, these measurements may be fed back to a sensing initiator (implemented in sharing AP 2005 in this example). In some implementations, if there is more than one shared AP, this measurement feedback may be triggered by a trigger frame sent from the Multi-AP sensing initiator (e.g., AP 2005). In some implementations, the feedback is sent simultaneously by the shared APs using orthogonal resources, based on the trigger frame.

In some implementations, an NDPA frame is configured accommodate sensing functionalities, e.g., to facilitate both implicit and explicit sensing using NDPA.

For example, in some implementations a sensing (SENS) NDPA variant is provided for sensing purposes. In some implementations, a SENS NDPA may be indicated by setting an NDPA Announcement Type subfielde.g., such that the setting of this subfield to 11 indicates an NDPA variant of EHT and EHT+ amendments.

In some implementations, a special STA Info field may be defined, e.g., using a special AID. In some implementations, the special STA info field may signal more information which is common to all the STAs signaled in this NDP Announcement. In some implementations, this common information may include a version of future EHT+ amendments, such as SENS.

In some implementations, a SENS NDPA variant may be indicated by using bits (e.g., 3 or more bits) of a Sounding Dialog Token for the indication of the NDPA Announcement Type. Accordingly, some entries (e.g., combinations of bits) may be used to indicate legacy NDPA variants and one of the new available entries may be used to indicate a SENS NDPA variant.

In some implementations, a SENS NDPA variant may be configured to trigger transmission of an NDP in the uplink (i.e., from non-AP STAs to AP STAs). Accordingly, in some implementations, STAs signaled in the STA Info field of the SENS NDPA frame may parse the STA Info differently if the frame is indicated as a trigger NDPA frame. In this scenario, in some implementations, an indication may be included in the NDPA frame to signal that the NDPA frame is an NDPA trigger frame.

In some implementations, a field may be added to the NDPA frame to indicate the type of the NDPA frame (e.g., trigger NDPA or traditional NDPA). In some implementations, a special STA Info field of the NDPA frame may include a subfield to indicate the type of the NDPA. In some implementations, one or more bits of the STA Info field may be used to indicate that the NDPA frame is trigger frame.

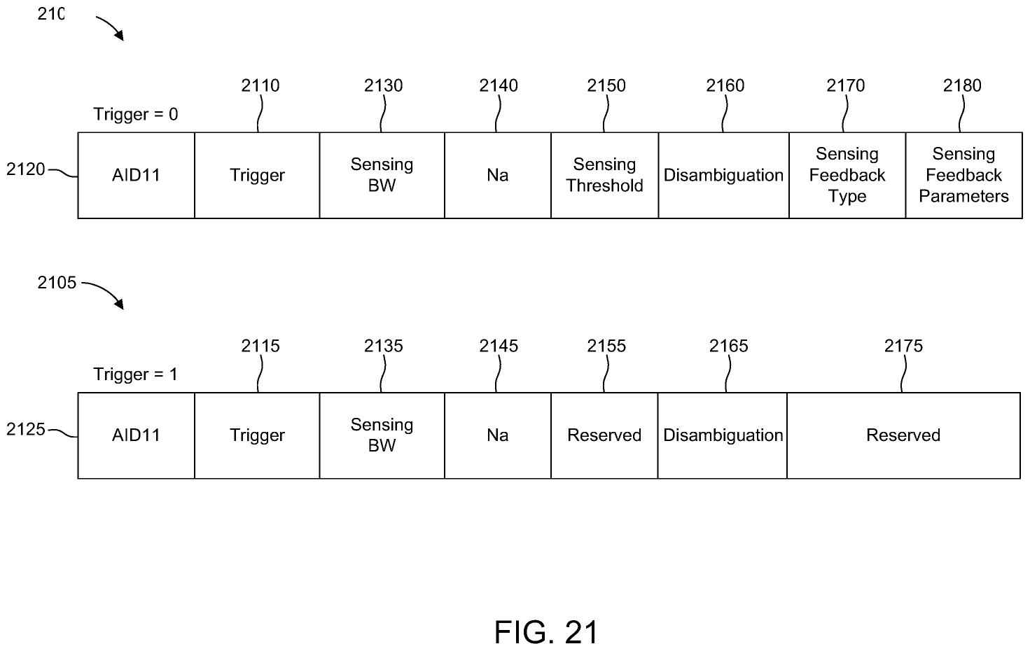

In some implementations, the STA Info field of the SENS NDPA variant may be configured to provide or facilitate sensing functionality. FIG. 21 illustrates example STA info fields 2100 and 2105, where a bit is used to indicate whether the NDPA frame is a trigger frame. Here, a trigger subfield may indicate the type of the NDPA. In this example, if the Trigger subfield is one bit, Trigger=1 may indicate that the NDPA frame is a triggering frame and Trigger=0 may indicate a traditional NDPA frame.

In FIG. 21, example STA info field 2100 indicates that the NDPA frame is a trigger frame by including trigger subfield 2110=1. example STA info field 2105 indicates that the NDPA frame is a traditional NDPA frame by including trigger subfield 2115=0.

An AID 11 subfield may indicate an association identifier. In this example, AID 11 subfield 2120 and subfield 2125 both indicate association identifiers (i.e., the functionality of this subfield is the same in both cases).

A sensing BW subfield may indicate the bandwidth of the sensing measurement feedback (traditional NDPA) or the bandwidth of the solicited NDP to be transmitted in the uplink (trigger NDPA). In this example, sensing BW subfield 2130 indicates the bandwidth of the solicited NDP to be transmitted in the uplink, and sensing BW subfield 2135 indicates the bandwidth of the sensing measurement feedback.

A Na subfield may indicate a number of antennas used in the sensing measurement, or the number of antennas used to send the NDP solicited by a trigger NDPA. In this example, Na subfield 2140 indicates a number of antennas used for sensing measurement, and NA subfield 2145 indicates a number of antennas used to send an NDP solicited by the trigger NDPA.

A sensing threshold subfield may indicate a threshold at which the sensing receiver may send the sensing measurement feedback depending on the sensing feedback type. The sensing threshold subfield is used in a traditional NDPA, but not in a trigger NDPA. Accordingly, STA info field 2100 includes sensing threshold subfield 2150, whereas STA info field 2105 includes a reserved field 2155 that is not a sensing threshold subfield. In some implementations, sensing threshold values may be different for different sensing feedback types. For example, in some implementations, a sensing threshold value for AoA corresponds to a AoA sensing feedback type, whereas a sensing threshold value for Doppler corresponds to a Doppler sensing feedback type. In some implementations, if the CSI variation is larger than the Sensing Threshold, the Sensing Threshold subfield may encode a quantized value of the sensing threshold which may be a normalized value in a closed interval [0,1].

The Disambiguation subfield may be used by legacy VHT STAs to avoid wrongly finding their AIDs in the STA Info field of other amendments (e.g., HE, EHT, and SENS). STA info field 2100 includes disambiguation subfield 2160, and STA info field 2105 includes disambiguation subfield 2165,

A sensing feedback type subfield may indicate a specific type of sensing feedback. By indicating the sensing feedback type, the sensing initiator may dynamically change the sensing feedback type during the sensing session. A sensing feedback type subfield is used in a traditional NDPA, but not in a trigger NDPA. Accordingly, STA info field 2100 includes sensing feedback type subfield 2170, whereas STA info field 2105 includes a reserved field 2175 that is not a sensing threshold subfield.

A sensing feedback parameters subfield may indicate more parameters to specify the sensing feedback. Sensing feedback parameters may include, for example, sensing resolution, sensing accuracy, etc. A sensing feedback parameters subfield is used in a traditional NDPA, but not in a trigger NDPA. Accordingly, STA info field 2100 includes sensing feedback parameters subfield 2180, whereas STA info field 2105 includes reserved field 2175 that is not a sensing parameters subfield.

In some implementations, a STA info field may include a subfield for indicating a number of NDP sequences (not shown). Such number-of-NDP-sequences subfield may indicate the number of NDP sequences the STA should transmit in response to this NDPA in a given time, e.g., for time observations.

In some implementations, the NDPA may be designed with the Sensing BW signaled implicitly as the entire BSS bandwidth. In some implementations, this is done because sensing resolution is a function of bandwidth, and increases in resolution as bandwidth increases. In this case, in some implementations, sensing BW is not explicitly signaled in the NDPA. Accordingly, the bits used to encode the Sensing BW may be marked as reserved or may be used for other signaling purposes in case of traditional NDPA. In case of trigger NDPA (i.e., Trigger=1), some or all these bits and may be used to indicate the resource which may be used by the sensing receiver to send the NDP in the uplink. In some implementations, the bits and/or subfield may be renamed (e.g., as a sensing resource subfield) For example, sensing BW subfield 2135 of STA info field 2105 may be replaced with a sensing resource subfield. In some implementations, a sensing resource subfield may include: (1) an indication of the bandwidth which may be used for NDP transmission; (2) an indication of the orthogonal code or sequence, which may be used for orthogonal transmission of the NDP on the entire BSS bandwidth; and/or (3) an indication of a subset of the subcarriers which may be used for the interleaved transmission of the NDP on the entire BSS bandwidth. Such interleaved transmission may be referred to as interleaved NDP.

In some implementations, interleaved NDP includes an NDP where orthogonal subsets of the subcarriers are used for different STAs. In some implementations, in interleaved NDP, orthogonal subsets of the subcarriers may be used for the orthogonal transmission of the NDP on the entire BSS bandwidth, or on a part of the BSS bandwidth. For example, in some implementations, odd subcarriers may form one subset and even subcarriers may form another set. In another example, the set of the subcarrier indices {1, 4, 7, . . . } may form a first subset, the set of the subcarrier indices {2, 5, 8, . . . } may form a second subset, and the set of the subcarrier indices {3, 6, 9, . . . } may form a third subset. In some implementations, the subcarriers and/or bandwidth can be divided into any desired number of subcarriers and/or portions.

In some implementations, the Sensing Threshold may be encoded in two or more bits. For example, in some implementations, the Sensing Threshold may be a one-to-one mapping to a certain quantization level of the normalized threshold in the closed interval [0,1]. Table 4 shows example 2-bit encoding of the Sensing Threshold subfield.

TABLE 4

| Sensing Threshold subfield | Sensing threshold value |
|---|---|
| 00 | Threshold < 0.25 |
| 01 | 0.25 ≤ Threshold < 0.5 |
| 10 | 0.5 ≤ Threshold < 0.75 |
| 11 | Threshold ≥ 0.75 |

In some implementations, the Sensing Threshold subfield may be replaced by two subfields, which may be referred to as a Sensing Threshold Resolution subfield and a Sensing Threshold Value subfield. In some implementations, the Sensing Threshold Resolution may indicate the number of quantization levels for the sensing threshold, and the Sensing Threshold Value may indicate the signaled sensing threshold to the sensing receiver. In some implementations, the Sensing Threshold Resolution may be encoded using 1 bit, e.g., where Sensing Threshold Resolution=0 may indicate 4 quantization levels and Sensing Threshold Resolution=1 may indicate 8 quantization levels. Accordingly, the Sensing Threshold Value subfield may be encoded using 3-bits where each value may signal one of the quantization levels. Any suitable bit encoding and/or number of quantization levels are usable in different implementations.

In some implementations, the CSI variation may refer to CSI variation in the time domain or CSI variation in the frequency domain. In some implementations, CSI may be represented as the time domain CSI or the frequency domain CSI. In other words, in some implementations, CSI variation may be referred to as the time domain CSI variation over a period of time, or the frequency domain CSI variation over a period of time, or the time domain CSI variation over a certain bandwidth, or the frequency domain CSI variation over a certain bandwidth. Accordingly, the CSI variation type and the measurement time duration or the measurement frequency duration of the CSI variation may be included in the NDP Announcement frame or other control frame.

CSI may be defined in the time domain or frequency domain, e.g., measured at the sensing receiver. For sensing, the CSI may be represented by a single complex number, e.g., h(t)=a(t)e^{jθ(t)}, where a represents the magnitude of the CSI and θ represents the phase of the CSI. In general, a vector of such complex numbers may be used to represent the CSI. Each element of this vector may represent the CSI at certain path (e.g., the first significant path) in time domain, or at certain subcarriers in frequency domain. The variation of the CSI may be defined as the change of the CSI over time. The change may be measured by the ratio of the CSIs at different measurement incidences, e.g.,

$$\frac{h ( {t}_{2} )}{h ( {t}_{1} )} = \frac{a ( {t}_{2} )}{a ( {t}_{1} )} {e}^{j ( θ ( {t}_{2} ) - θ ( {t}_{1} ) )} , for time {t}_{2} > {t}_{1}$$

From the expression above, the CSI Variation can be further partitioned into two components: CSI magnitude variation,

$${R}_{\vert h \vert} = \frac{a ( {t}_{2} )}{a ( {t}_{1} )} or {R}_{\vert h \vert} = 20 log 10 ( \frac{a ( {t}_{2} )}{a ( {t}_{1} )} )$$

[dB] and CSI phase variation, Δθ=θ(t₂)−θ(t₁) or Δθ=|θ(t₂)−θ(t₁)|.

In the trigger based or non-trigger based sensing procedure, the responder or the NDP sensing receiver may estimate the CSI and compute the CSI variations, which may include CSI magnitude variation R_{|h|} and CSI phase variation Δθ.

The sensing responder or NDP sensing receiver may feedback R_{|h|} and/or Δθ or information related R_{|h|} and/or Δθ, after receiving a trigger frame if the sensing is trigger based.

In some implementations, the sensing responder or NDP sensing receiver may feed back the values of R_{|h|} and/or Δθ with certain equalization determined by the number of bits available for those values.

In some implementations, the sensing initiator or the NDP sensing transmitter may set and send thresholds for R_{|h|} and/or Δθ, denoted as R_{|h|}^{th} in and Δθ^{th}, respectively, to the sensing responder or NDP sensing receiver. In some implementations, the sensing responder or NDP sensing receiver may send a feedback with values of R_{|h|} and/or Δθ to the sensing initiator or the NDP sensing transmitter if R_{|h|}≥R_{|h|}^{th} and/or Δθ≥Δθ^{th}; otherwise, the sensing initiator or the NDP sensing transmitter remains silent without any feedback. In some implementations, the sensing responder or NDP sensing receiver may also feedback a bit b_{|h|} (or a set of bits) with certain value (e.g., b_{|h|}=1) to indicate R_{|h|}≥R_{|h|}^{th} and with another value (e.g., b_{|h|}=0) to indicate R_{|h|}<R_{|h|}^{th} or keep silent without any feedback. In some implementations, the sensing responder or NDP sensing receiver may also feedback a bit b_{θ} (or a set of bits) with certain value (e.g., b_{θ}=1) to indicate Δθ≥Δθ^{th} and with another value (e.g., b_{θ}=0) to indicate Δθ<Δθ^{th} or keep silent without any feedback.

In some implementations, the aforementioned thresholds, R_{|h|}^{th} and Δθ^{th}, may be sent from the sensing initiator or the NDP sensing transmitter using an NDP Announcement frame, or a trigger frame, or any setup frame that starts a sensing procedure. In some implementations, the sensing initiator or the NDP sensing transmitter may pass those threshold to PHY from MAC via the TXVECTOR. In some implementations, the sensing responder or NDP sensing receiver may receive those thresholds via MAC to PHY interface via the RXVECTOR.

In some implementations, the sensing initiator or the NDP sensing transmitter may set and send the minimum value for R_{|h|}, denoted as R_{|h|}^{min} in dB, quantization level or the number of bits Nₕ to be used for indicating the CSI variation in the feedback, called CSI Variation Feedback (CVFₕ), and the scaling factor for each quantization level in dB αₕ. It is noted that with these parameters, in some implementations, the maximum CSI variation can be calculated as R_{|h|} ^{max}=R_{|h|} ^{min}+αₕ(2^{N}^{ₕ}−1) [dB]. Nₕ may also be predefined. In some implementations, the values of these three parameters may be application dependent. In some implementations, the values of these three parameters may be different for different sensing procedures or phases. Accordingly, in some implementations, CVFₕ may be a subfield or an element in MAC and PHY interface RX/TXVECTORs, along with R_{|h|} ^{min}, Nₕ and αₕ.

In some implementations, the sensing responder or NDP sensing receiver, after generating R_{|h|}, may feedback a particular value for CVFₕ, e.g., all 0s, to indicated R_{|h|}<R_{|h|} ^{min} or keep silent without any feedback, or feedback another particular value for CVFₙ, e.g., all 1s, if R_{|h|}>R_{|h|} ^{max}. If R_{|h|} ^{min}≤R_{|h|}≤R_{|h|} ^{max}, the CVFₕ value may be set to nₕ, where nₕ is an integer and satisfies the following equation:

$${n}_{h} = ⌊ ( {R}_{\vert h \vert} - {R}_{\vert h \vert}^{min} ) / {α}_{h} ⌋ such that {n}_{h} ∈ \{ 0 , 1 , 2 , … , {2}^{{N}_{h}} - 1 \}$$

In some implementations, the aforementioned parameters, R_{|h|} ^{min}, Nₕ and αₕ, may be sent from the sensing initiator or the NDP sensing transmitter using an NDP Announcement frame, or a trigger frame, or any setup frame that starts a sensing procedure.

In some implementations, the sensing initiator or the NDP sensing transmitter may set and send the minimum value for Δθ, denoted as Δθ^{min} in degree or radius, quantization level or the number of bits N_{θ} to be used for indicating the CSI variation in phase in the feedback, called CSI Phase Variation Feedback (CV F_{θ}), and the scaling factor for each quantization level in degree or radius de. It is noted that with these parameters, in some implementations, the maximum CSI variation can be calculated as Δθ^{max}=Δθ^{min}+α_{θ}(2^{N}^{_{θ}}−1). N_{θ} may also be predefined. In some implementations, the values of these three parameters may be application dependent. In some implementations, the values of these three parameters may be different for different sensing procedure or phase. Accordingly, in some implementations, CV F_{θ} may be a subfield or an element in MAC and PHY interface RX/TXVECTORs, along with Δθ^{min}, N_{θ} and α_{θ}.

In some implementations, the sensing responder or NDP sensing receiver, after generating R_{|h|}, may feedback a particular value for CV F_{θ}, e.g., all 0s, to indicated Δθ<Δθ^{min}, may keep silent without any feedback, or may feedback another particular value for CVF_{θ}, (e.g., all 1s, if Δθ>Δθ^{max}). In some implementations, if Δθ^{min}≤Δθ≤Δθ^{max}, the CV F_{θ} value may be set to n_{θ}, where n_{θ} is an integer and satisfies the following equation:

$${n}_{θ} = ⌊ ( Δ θ - {Δθ}^{min} ) / {α}_{h} ⌋ such that {n}_{θ} ∈ \{ 0 , 1 , 2 , … , {2}^{{N}_{θ}} - 1 \}$$

In some implementations, the aforementioned parameters, Δθ^{min}, N_{θ} and α_{θ}, may be sent from the sensing initiator or the NDP sensing transmitter using an NDP Announcement frame, or a trigger frame, or any setup frame that starts a sensing procedure.

In some implementations, for any method that measures the CSI variation, the CSI variation may be a bounded function of multiple CSI measurements over time and/or frequency with a finite lower bound or a minimum value and a finite upper bound or a maximum value. In some implementations, the feedback of such a variation may be mapped to a value in a predefined range, e.g., [0, 1], where the lower bound or the minimum variation value of the CSI variation function maps to 0 (or −1) and the upper bound or the maximum variation value of the CSI variation function maps to 1. In some implementations, during a sensing process, the sensing initiator or the NDP sensing transmitter may send a value, γ, or a set of values {γᵢ, i=1, . . . , M} (where M is an integer larger than 1) between the predefined range (e.g., [0, 1]) to the sensing responder or the NDP sensing receiver and request a feedback from the sensing responder or the NDP sensing receiver about the relationship (e.g., larger than a received value or smaller than a received value, or containment between two values) between the measured and computed CSI variation value and the value γ, or a set of values {γᵢ, i=1, . . . , M} received. In some implementations, the requested feedback may also include the measured CSI variation value. In some implementations, the quantization level or the number of bits used for such a feedback may be signaled by the sensing initiator or the NDP sensing transmitter. In some implementations, along with such information, the feedback may include the lower bound or the minimum variation value and the upper bound or the maximum variation values, e.g., such that the feedback receiver may map the feedback value to the actual CSI variation value.

In some implementations, the CSI variation is defined based on a correlation of CSI in time and frequency. An example procedure described as follows.

In some implementations, first, a sensing receiver may generate a CSI matrix:

$$H = [ \begin{matrix}{h}_{11} & … & {h}_{{N}_{t}} \\ ⋮ & ⋱ & ⋮ \\ {h}_{1 {N}_{f}} & … & {h}_{{N}_{t} {N}_{f}}\end{matrix} ] = [ {H}_{1} , … , {H}_{{N}_{t}} ] = {[ {R}_{1}^{T} , … , {R}_{{N}_{f}}^{T} ]}^{T}$$

Here, each element of H matrix, hᵢⱼ, may be a complex number and may represent the CSI value at time tᵢ and frequency fⱼ. Each element of H matrix, hᵢⱼ may also be a real number if only the magnitude or the phase, or a function of the magnitude and phase of the CSI is considered.

Nₜ and N_{f} are the total number of time domain and frequency domain, respectively, CSI values collected for computing the CSI variation.

Hᵢ is the i-th column of matrix H and Rⱼ is the j-th row of matrix H. Each column of matrix H may be generated from an OFDM symbol in the LTF (long training field) of a received NDP sent by a sensing transmitter via a channel estimation algorithm. H may be formed from multiple LTFs in a NDP and/or multiple NDPs.

The i-th column of H matrix, Hᵢ, may represent the CSI at time tᵢ over a channel bandwidth. In some implementations, the time difference between adjacent columns of H matrix, Δtⱼ_{ᵢ}=tⱼ−tᵢ may be a constant or a variable. In some implementations, the total number of columns of H matrix, Nₜ and Δtⱼᵢ may be signaled from the sensing transmitter via NDP announcement frame, trigger frame or other control frames. In some implementations, the total number of columns of H matrix, Nₜ and Δtⱼᵢ may also or alternatively be signalled from a sensing initiator via a MAC frame. In some implementations, the number of NDPs to be transmitted may also be signaled in frames mentioned above.

In some implementations, the j-th row of H matrix, Rᵢ, may represent the CSI at frequency fⱼ over a certain time duration. In some implementations, the frequency difference between adjacent rows of H matrix, Δfⱼᵢ=fⱼ−fᵢ may be a constant or a variable. In some implementations, the total number of rows of H matrix, N_{f} and Δfⱼᵢ may be signaled from the sensing transmitted via NDP announcement frame, trigger frame or other control frames. In some implementations, the total number of rows of H matrix, N_{f} and Δfⱼᵢ may also or alternatively be signaled from a sensing initiator via a MAC frame. In some implementations, Δfⱼᵢ may be represented by a number of subcarriers, N_{g}(i, j), in an OFDM transmission setup. In some implementations, this number may be a constant in a sensing instance. N_{g}(i, j), may also be signalled in frames mentioned above.

In some implementations, the correlation of CSI in the time domain may be represented as follows. For any i and j in {1, 2, . . . , Nₜ} define

$${r}_{f} ( i , j ) = \frac{{H}_{i}^{H} {H}_{j}}{‖ {H}_{i} ‖ ‖ {H}_{j} ‖}$$

A function Fₜ, of {rₜ(i, j), i, j=1, . . . , Nₜ} may be defined as the correlation of CSI in time domain:

$${r}_{t} = {F}_{t} ( {r}_{t} ( i , j ) , i , j = 1 , … , {N}_{t} )$$

Examples of this function may be the mean of {rₜ(i, j), i, j=1, . . . , Nₜ}, the median of {∥rₜ(i, j)∥, i, j=1, . . . , Nₜ}, or a value r′ₜ which makes ∥r′ₜ∥ to be the median of {∥rₜ(i, j)∥, i, j=1, . . . , Nₜ}.

In some implementations, the correlation of CSI in frequency domain may be represented as follows:

For any i and j in {1, 2, . . . , N_{f}}, define

$${r}_{f} ( i , j ) = \frac{{R}_{i}^{H} {R}_{j}}{‖ {R}_{i} ‖ ‖ {R}_{j} ‖}$$

A function F_{f}, of {r_{f}(i, j), i, j=1, . . . , N_{f}} may be defined as the correlation of CSI in the frequency domain:

$${r}_{f} = {F}_{f} ( {r}_{f} ( i , j ) , i , j = 1 , … , {N}_{f} )$$

Examples of this function may be the mean of r_{f}(i, j), i, j=1, . . . , N_{f}, the median of ∥r_{f}(i,j)∥, i, j=1, . . . , N_{f}, or a value r′_{f} which makes ∥r′_{f}∥ to be the median of {∥r_{f}(i, j)∥, i, j=1, . . . , N_{f}}.

In some implementations, the sensing responder may feedback the pair (rₜ, r_{f}) as CSI variation to the sensing transmitter or sensing initiator. Or a function of the pair (rₜ, r_{f}), Gᵣ(rₜ, r_{f}). In some implementations, this function may be a polynomial function of rₜ and r_{f}, which may put different weights on rₜ and r_{f}, or any function, e.g., exponential or log functions, to emphasize or de-emphasize the sensitivity of rₜ and r_{f}.

In some implementations, different sensing feedback types may have different threshold definitions and parameters. Accordingly, in some implementations, different threshold metrics and associated parameters may be defined by sensing initiator or NDP sensing transmitter or any set up frame that starts a sensing procedure.

In some implementations, CSI methods and procedures described above may be used for sensing feedback type,

In some implementations, a threshold for AoA variation Δθ_{AoA} (change in the measured from its previous value) may be defined for sensing feedback type, AoA (θ_{AOA}). In some implementations, the variation measured in AoA (Δθ_{AOA}) is dependent on the number of antennas, Na, at the STA responder receiver, while the required threshold AoA, Δθ_{AoA}^{h} may be application specific. In some implementations, the sensing variation threshold for AoA, Δθ_{AoA}^{h}, may be indicated by sensing initiator or the NDPA transmitter using an NDP announcement frame or any setup frame that starts a sensing procedure.

In some implementations, the sensing responder or NDP receiver, after receiving the Δθ_{AoA}^{h}, may feed back a particular value for AoA variation, e.g., all 0s, to indicated Δθ_{AOA}<Δθ_{AoA}^{min} or may keep silent without any feedback, or may feed back another particular value, e.g., all 1s, if Δθ_{AOA}>Δθ_{AoA}^{max}. In some implementations, if Δθ_{AoA}^{min}≤Δθ_{AoA}≤Δθ_{AoA}^{max}, max the AoA variation field may be set to n_{θ}^{AoA}, where n_{θ}^{AoA} is an integer and satisfies the following equation:

$${n}_{θ}^{A o A} = ⌊ ( {Δθ}_{A o A} - Δ {θ}_{A o A}^{min} ) / {α}_{θ}^{A o A} ⌋ such that {n}_{θ}^{A o A} ∈ \{ 0 , 1 , 2 , … , {2}^{{N}_{θ}^{A o A}} - 1 \}$$

In some implementations, for sensing feedback type, ToF (T_{ToF}) threshold for ToF variation, ΔT_{TOF} may be defined. In some implementations, the sensing variation threshold for TOF, ΔT_{TOF}^{h}, may be indicated by sensing initiator or the NDPA transmitter using an NDP announcement frame or any setup frame that starts a sensing procedure.

In some implementations, the sensing responder or NDP sensing receiver, after receiving the ΔT_{ToF}^{h}, may feed back a particular value for ToF variation, e.g., all 0s, to indicated ΔT_{TOF}<ΔT_{ToF}^{min}, may keep silent without any feedback, or may feedback another particular value, e.g., all 1s, if ΔT_{TOF}>ΔT_{TOF}^{max}. In some implementations, if ΔT_{TOF}^{min}≤ΔT_{TOF}≤ ΔT_{TOF}^{max} the ToF variation field may be set to n_{ToF}, where n_{ToF} is an integer and satisfies the following equation:

$${n}_{T o F} = ⌊ ( Δ {T}_{T o F} - Δ {T}_{T o F}^{min} ) / {α}_{T o F} ⌋ such that {n}_{T o F} ∈ \{ 0 , 1 , 2 , … , {2}^{{N}_{ToF}} - 1 \}$$

In some implementations, for sensing feedback type, range (R) threshold for range variation, ΔR may be defined. In some implementations, the sensing variation threshold for range, ΔR_h, may be indicated by the sensing initiator or the NDPA transmitter using an NDP announcement frame or any setup frame that starts a sensing procedure.

In some implementations, the sensing responder or NDP sensing receiver, after receiving the ΔRₕ, may feedback a particular value for ToF variation, e.g., all 0s, to indicated ΔR<ΔR^{min} or may keep silent without any feedback, or may feed back another particular value, e.g., all 1s, if ΔR>ΔR^{max}. In some implementations, if ΔR^{min}≤ΔR≤ΔR^{max}, the range variation field may be set to n_{R}, where n_{R} is an integer and satisfies the following equation:

$${n}_{R} = ⌊ ( Δ R - Δ {R}^{min} ) / {α}_{R} ⌋ such that {n}_{R} ∈ \{ 0 , 1 , 2 , … , {2}^{{N}_{R}} - 1 \}$$

In some implementations, for sensing feedback type, Doppler shift (F_{d}) threshold for Doppler variation, ΔF_{d} may be defined. In some implementations, the sensing variation threshold for Doppler, ΔF_{d}^{h}, may be indicated by sensing initiator or the NDPA transmitter using an NDP announcement frame or any setup frame that starts a sensing procedure.

In some implementations, the sensing responder or NDP sensing receiver, after receiving the ΔF_{d}^{h}, may feed back a particular value for Doppler shift variation, e.g., all 0s, to indicated ΔF_{d}^{h}<ΔF_{d}^{min}, may keep silent without any feedback, or may feed back another particular value, e.g., all 1s, if ΔF_{d}>ΔF_{d}^{max}. In some implementations, if ΔF_{d}^{min}≤ΔF_{d}≤ΔF_{d}^{max}, the range variation field may be set to n_{F}_{_{d}}, where n_{F}_{_{d}} is an integer and satisfies the following equation:

$${n}_{{F}_{d}} = ⌊ ( Δ {F}_{d} - Δ {F}_{d} ) / {α}_{{F}_{D}} ⌋ such that {n}_{{F}_{d}} ∈ \{ 0 , 1 , 2 , … , {2}^{{N}_{{F}_{D}}} - 1 \}$$

In some implementations, the sensing receivers or sensing responders may indicate that they are capable of performing threshold-based sensing based on the CSI variation. In some implementations, this capability may be indicated in the MAC Capabilities information filed in the association or reassociation procedure to the sensing initiator. In some implementations, one bit may be used to signal this capability, e.g., such that value of 0 indicates that the threshold-based sensing is not supported by the STA and a value of 1 indicates that the threshold-based sensing is supported by the STA. Accordingly, in some implementations, the sensing setup, the sensing initiator may communicate the threshold-based sensing parameters to the sensing receivers or sensing responders which supports threshold-based sensing.

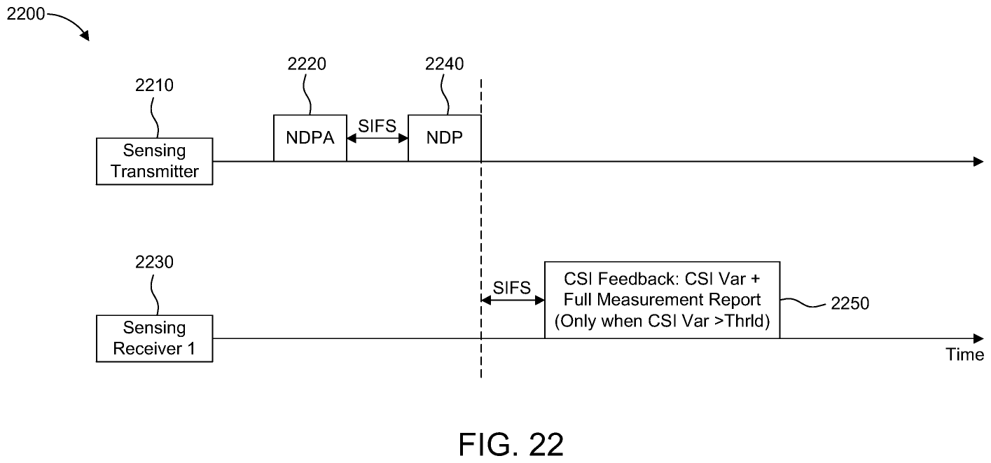

FIG. 22 is a signaling diagram which illustrates an example threshold-based non-TB sounding sequence 2200. In this example, threshold based non-TB sensing sequence 2200 is initiated by the sensing transmitter 2210 which transmits an individually addressed sensing NDP Announcement (NDPA) frame 2220, which includes one STA Info field, to sensing receiver 2230. After a SIFS, the sensing transmitter 2210 transmits a sensing NDP 2240 to sensing receiver 2230. In some implementations, the sensing receiver 2230 responds, after a SIFS, with CSI feedback 2250.

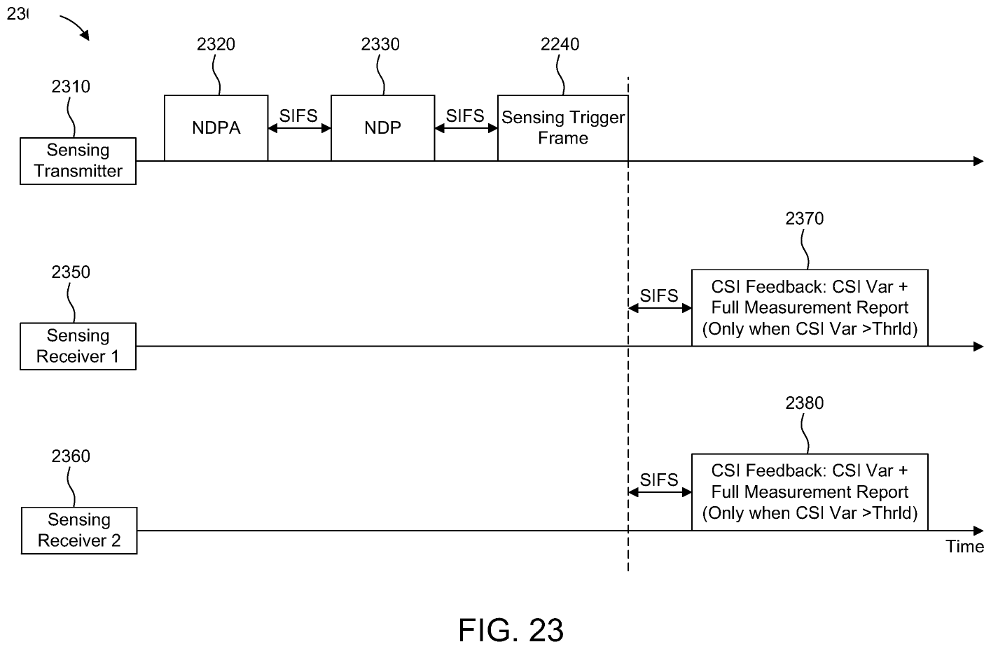

FIG. 23 is a signaling diagram which illustrates an example threshold-based TB sounding sequence 2300. In this example, threshold based TB sensing sequence 2300 is initiated by the sensing transmitter 2310 transmitting a broadcast sensing NDP Announcement frame 2320 with two or more STA Info fields, followed after a SIFS by a sensing NDP 2330, followed after a SIFS by a sensing Trigger frame 2340. Each sensing receiver 2350, 2360 responds after a SIFS with a TB PPDU 2370, 2380 (e.g., an EHT or beyond TB PPDU) which includes CSI feedback.

It is noted that in both threshold based non-TB and TB sounding sequences, the NDPA frame may be also sent by the sensing initiator.

In some implementations, CSI feedback which is sent by the sensing receiver may include the following information. The CSI feedback may include CSI variation values, which may be or include time domain or frequency domain CSI variation. In some implementations, if the CSI variation value represents frequency domain CSI variation, it may indicate the following parameters, such as, but not limited to, the covered frequency subcarriers, grouping information (e.g., how many subcarriers are grouped together to get one CSI value), number of quantization bits for the reported value, covered BW, etc. In some implementations, if the CSI variation value represents time domain CSI variation, it may include, but is not limited to, resolution range, the size of IFFT, the number of power delay profile values, covered BW, number of paths included in the multi-path calculation, etc.

In some implementations, the CSI feedback may include a full sensing measurement report only when the CSI variation larger than the threshold. In some implementations, the threshold based sensing may be indicated by the frame sent from sensing transmitter or initiator, e.g., NDPA or NDP or Trigger frame or any other control frame. In some implementations, the full sensing measurement report may be or include the representation in time domain or in frequency domain. In some implementations, if the full measurement report is represented in the frequency domain, it may indicate the following parameters but not limited to, the covered frequency subcarriers, grouping information (e.g., how many subcarriers are grouped together to get one CSI value), number of quantization bits for the reported values, compressed measurement report or not, covered BW, etc.; if the full measurement report is represented in time domain, it may include but not limited to the resolution range, the size of IFFT, the number of power delay profile values, covered BW, number of paths included in the multi-path calculation, etc.

In some implementations, the resource mentioned above may be in frequency, time, space, and/or code domains.

Although the solutions described herein consider 802.11, it is understood that the solutions described herein are not restricted to this scenario and are applicable to other wireless systems as well.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A station (STA), comprising:
receiver circuitry configured to receive a null data packet announcement (NDPA) frame which indicates a CSI variation threshold; and
transmitter circuitry configured to transmit, responsive to a measured CSI variation exceeding the threshold, a measurement report which includes an indication of the measured CSI variation within predefined boundaries.

22. The STA of claim 21, wherein the CSI variation comprises a ratio of CSI measured at a first instance to CSI measured at a second instance.

23. The STA of claim 21, wherein the CSI variation comprises a change in the measured CSI over time.

24. The STA of claim 21, wherein the CSI variation comprises a change in the measured CSI magnitude and/or a change in measured CSI phase, over time.

25. The STA of claim 21, wherein the CSI variation comprises a CSI magnitude variation and a CSI phase variation.

26. The STA of claim 21, wherein the CSI variation comprises time-domain CSI variation and/or frequency-domain CSI variation.

27. The STA of claim 21, wherein the measurement report is transmitted responsive to the measured CSI variation exceeding the threshold and receiving a trigger frame.

28. The STA of claim 21, wherein the indication of the measured CSI variation is based on a normalized value of the measured CSI variation.

29. The STA of claim 21, wherein the NDPA frame indicates the CSI variation threshold, in a subfield, by a representation of a normalized value in a closed interval.

30. A method for reporting channel state information (CSI), the method comprising:
receiving a null data packet announcement (NDPA) frame which indicates a CSI variation threshold; and
responsive to a measured CSI variation exceeding the threshold, transmitting a measurement report which includes an indication of the measured CSI variation within predefined boundaries.

31. The method of claim 30, wherein the CSI variation comprises a ratio of CSI measured at a first instance to CSI measured at a second instance.

32. The method of claim 30, wherein the CSI variation comprises a change in the measured CSI over time.

33. The method of claim 30, wherein the CSI variation comprises a change in the measured CSI magnitude and/or a change in measured CSI phase, over time.

34. The method of claim 30, wherein the CSI variation comprises a CSI magnitude variation and a CSI phase variation.

35. The method of claim 30, wherein the CSI variation comprises time-domain CSI variation and/or frequency-domain CSI variation.

36. The method of claim 30, wherein the measurement report is transmitted responsive to the measured CSI variation exceeding the threshold and receiving a trigger frame.

37. The method of claim 30, wherein the indication of the measured CSI variation is based on a normalized value of the measured CSI variation.

38. The method of claim 30, wherein the NDPA frame indicates the CSI variation threshold, in a subfield, by a representation of a normalized value in a closed interval.

39. A station (STA), comprising:
transmitter circuitry configured to transmit a null data packet announcement (NDPA) frame which indicates a CSI variation threshold; and
receiver circuitry configured to receive, responsive to a measured CSI variation exceeding the threshold, a measurement report which includes an indication of the measured CSI variation within predefined boundaries.

40. The STA of claim 39, wherein the CSI variation comprises a ratio of CSI measured at a first instance to CSI measured at a second instance.
